(19) United States
(12) Patent Application Publication
(10) Pub. No.: US 2015/0294363 A1
(43) Pub. Date: Oct. 15, 2015

(54) PRIORITIZED LOCATION BASED AD DISPLAY

(71) Applicant: Bumper Glass LLC, Wayland, MA (US)

(72) Inventors: Carlos M. Bhola, New York, NY (US); Brian Harrison, Wayland, MA (US); Chidananda Khatua, Sunnyvale, CA (US); Moe Khosravy, Palo Alto, CA (US); Emad Eskandar, Swampscott, MA (US)

(73) Assignee: Bumper Glass LLC, Wayland, MA (US)

(21) Appl. No.: 14/682,768

(22) Filed: Apr. 9, 2015

Related U.S. Application Data
(60) Provisional application No. 61/978,123, filed on Apr. 10, 2014.

(51) Int. Cl. G06Q 30/02; G01S 19/13; B60K 35/00

(52) U.S. Cl. CPC G06Q 30/0266; B60K 35/00; G01S 19/13

(57) ABSTRACT

Systems and methods of displaying content from a vehicle are described. A vehicle location module can determine a vehicle location of the vehicle. A vehicle detection module can detect whether another vehicle is behind the vehicle. The vehicle detection module, responsive to the detection, can identify a vehicle type of the other vehicle and can determine a relative velocity of the other vehicle. A vehicle accelerometer module can measure a vehicle acceleration of the vehicle. A content retrieval module executing on the computing system can access a content based on the vehicle location, the vehicle type, the relative velocity, and the vehicle acceleration. A content prioritization module can select content based on the vehicle location, the vehicle type, the relative velocity, and the vehicle acceleration. An electrophoretic display responsive to the selection can display the selected content.

### CROSS-REFERENCE TO RELATED PATENT APPLICATIONS

This application claims priority from Provisional application U.S. Application 61/978,123, filed Apr. 10, 2014, incorporated herein by reference in its entirety.

### BACKGROUND

Current outdoor content delivery techniques targeting drivers and pedestrians are fairly limited. Some techniques are stationary and static, such as billboards and signs found on the sides of roads. Some are large stationary and active displays, such as large electronic displays found in large metropolitan areas, but these also are not targeted and are addressed to the general public passing by the display. There are also mobile but static displays, such as billboards on the sides of municipal buses. However, these too are not targeted and are also intended for the general public passing by.

### SUMMARY

At least one aspect is directed to a system for displaying content from a vehicle. The system can include a computing system having one or more processors placed on a vehicle. A vehicle location module executing on the computing system can access a vehicle location of the first vehicle from an external server via a communications unit. A vehicle detection module executing on the computing system can detect whether a second vehicle is behind the first vehicle based on a first sensor. The vehicle detection module, responsive to the detection, can identify a vehicle type of the second vehicle based on a second sensor and can determine a relative velocity of the second vehicle. A vehicle accelerometer module executing on the computing system can measure a vehicle acceleration of the first vehicle. A content retrieval module executing on the computing system can access a content based on the vehicle location, the vehicle type, the relative velocity, and the vehicle acceleration. A content prioritization module executing on the computing system can select content for display based on the vehicle location, the vehicle type, the relative velocity, and the vehicle acceleration. An electrophoretic display responsive to the selection can display the selected content.

At least one aspect is directed to a method of displaying content from a vehicle. The method can include accessing by a vehicle location module that executes on a computing system having one or more processors placed on a first vehicle a vehicle location of first vehicle from an external server via a communications unit. The method can include detecting by a vehicle detection module executing on the computing system whether a second vehicle is behind the first vehicle based on a first sensor. The method can include identifying by the vehicle detection module, responsive to the detection of the second vehicle, a vehicle type of the second vehicle based on a second sensor. The method can include determining by the vehicle detection module, responsive to the detection of the second vehicle, a relative velocity of the second vehicle. The method can include measuring by a vehicle accelerometer module executing on the computing system a vehicle acceleration of the first vehicle. The method can include accessing by a content retrieval module executing on the computing system a content based on the vehicle location, the vehicle type, the relative velocity, and the vehicle acceleration. The method can include selecting by a content prioritization module executing on the computing system a content based on the vehicle location, the vehicle type, the relative velocity, and the vehicle acceleration.

These and other aspects are described in detail below. The above-mentioned information and the following detailed description include illustrative examples of various aspects, and provide an overview or framework for understanding the nature and character of the claimed aspects. The drawings provide illustration and a further understanding of the various aspects, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawing:

FIG. 1 is a block diagram illustrating an architecture for a system for displaying content from a vehicle, according to an illustrative implementation;

FIG. 2A and FIG. 2B is the diagram of a physical layout of the circuitry for displaying content from a vehicle, according to an illustrative implementation;

FIG. 3 is a diagram illustrating an oblique view of the physical layers of the device for displaying content from a vehicle, according to an illustrative implementation;

FIG. 4 is a diagram illustrating a side view of the physical layers of the device for displaying content from a vehicle, according to an illustrative implementation;

FIG. 5 is a flow diagram depicting an example method of displaying content from a vehicle, according to an illustrative implementation;

FIG. 6 is a block diagram depicting a content delivery architecture for a system for displaying content from a vehicle, according to an illustrative implementation;

FIG. 7A is a block diagram depicting a network environment comprising client device in communication with a server device;

FIG. 7B is a block diagram depicting a cloud computing network comprising client device in communications with cloud service providers; and

FIG. 7C and FIG. 7D are block diagrams depicting computing devices useful in connection with the methods and systems described herein.

### DETAILED DESCRIPTION

The systems and methods described herein relate to displaying content from a vehicle. A computing system of a device can be attached to the vehicle. The computing system can determine vehicle location information and based on the vehicle location information retrieve proximate points of interest. The computing system can retrieve time information. The computing system can measure vehicle acceleration data. The computing system can detect whether another vehicle is following the vehicle and responsive to the detection determine vehicle type information of the other vehicle. The computing system can retrieve and select a content for display on the electrophoretic display based on the vehicle location information, vehicle acceleration data, proximate interest points, vehicle type information, and content bid price. By selecting a content for display based on the vehicle location information, vehicle acceleration data, proximate interest points, vehicle type information, as well as other data, the computing system can allow for targeted content delivery.

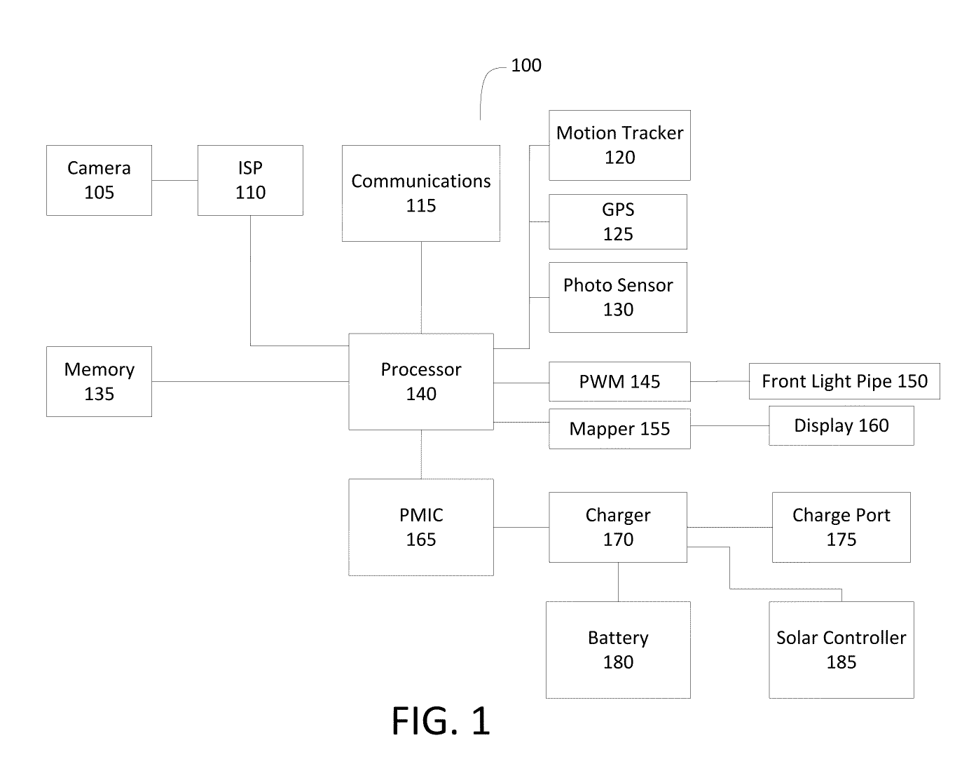

FIG. 1 illustrates a system architecture 100 for displaying content from a vehicle according to one implementation. The system 100 can be placed on the vehicle. The system 100 can be part of a single device or multiple devices. For example, one portion of the system can reside in the trunk of a vehicle but the remaining portion can be placed along the back window of the vehicle. The system 100 can include a camera 105, image signal processor (ISP) 110, communications unit 115, motion tracker 120, locator unit 125, photo sensor 130, memory 135, processor 140, pulse width modulator (PWM) unit 145, front light pipe 150, mapper 155, display 160, power management integrated circuit (PMIC) 165, charger unit 170, charge port 175, battery 180, and solar controller 185. The ISP 110, PWM 145, and mapper 150 can be incorporated into the processor 140.

The camera 105 can obtain an image or a series of images forming a video of the area in front of the camera 105. For example, if the camera 105 is attached to the back of the vehicle such that it is facing outward, the camera 105 can take an image of the area behind the vehicle in front of the camera 105. The camera 105 can obtain the image or series of images at a predetermined interval. For example, the camera 105 can obtain an image every 45 seconds to 30 minutes. The camera 105 can obtain the image or series of images based on a condition precedent. For example, responsive to the photo sensor 130 indicating the presence of another object in front of the photo sensor 130 behind the vehicle, the camera 105 can take an image or series of images of the area behind the vehicle. The camera 105 can be a digital camera of any type, such as a fixed lens camera, digital single-lens reflex camera, single lens translucent camera, or a mirror interchangeable-lens camera. The camera 105 can relay the image taken to the ISP 110 for further processing. The camera 105 can relay the image directly to the processor 140 for further processing. The camera 105 can be attached to a weight to maintain constant angle of the camera within the system 100 or a device that the camera can be placed in. For example, the camera can be mounted on a cylindrical barrel mount. The barrel mount can include a damper hinge to prevent the camera 105 from tilting from the vibrations. The barrel mount can also include a deadweight at the bottom of the barrel that can ensure that the cylindrical camera assembly is oriented at one angle irrespective of the orientation of the complete device encasing the system 100.

The ISP 110 can process the image taken by the camera 105 using any number of techniques for further processing by the processor 140. For example, the ISP 110 can introduce color into the image taken by applying a Bayer filter to the raw image from the camera 105. The ISP 110 can use a demosaicing algorithm to alter the color, contrast, and luminance of the image. The ISP 110 can reduce noise in the image by applying a low pass filter or a smoothing operation. The ISP can be incorporated into the processor 135.

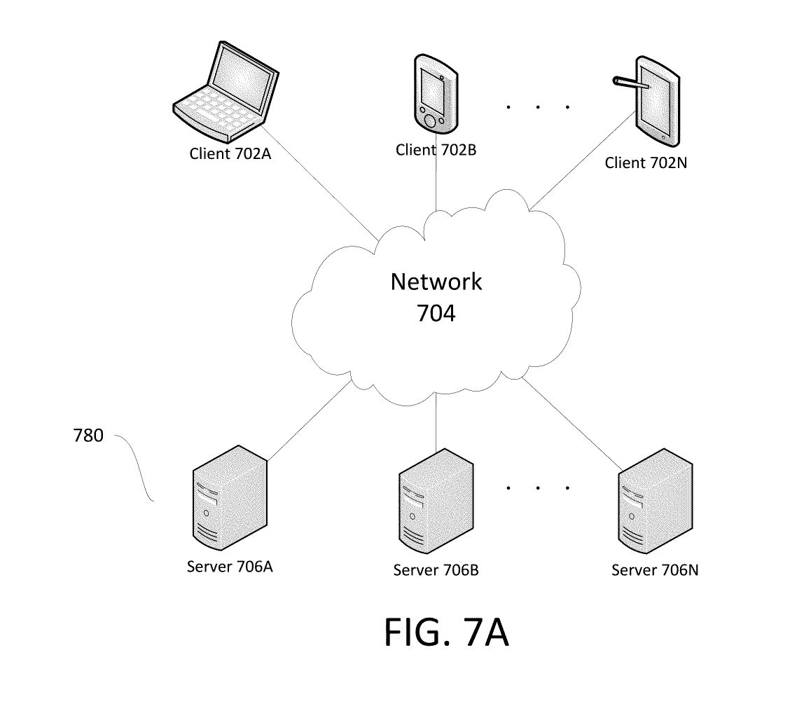

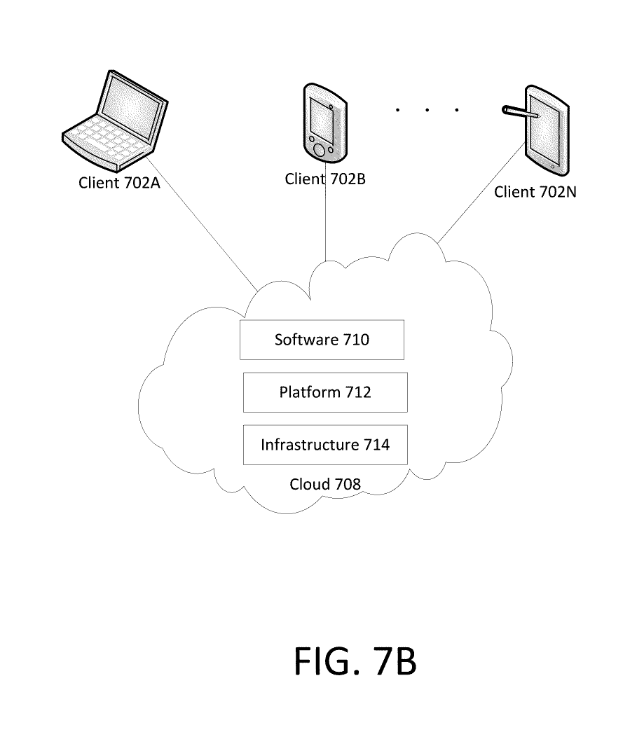

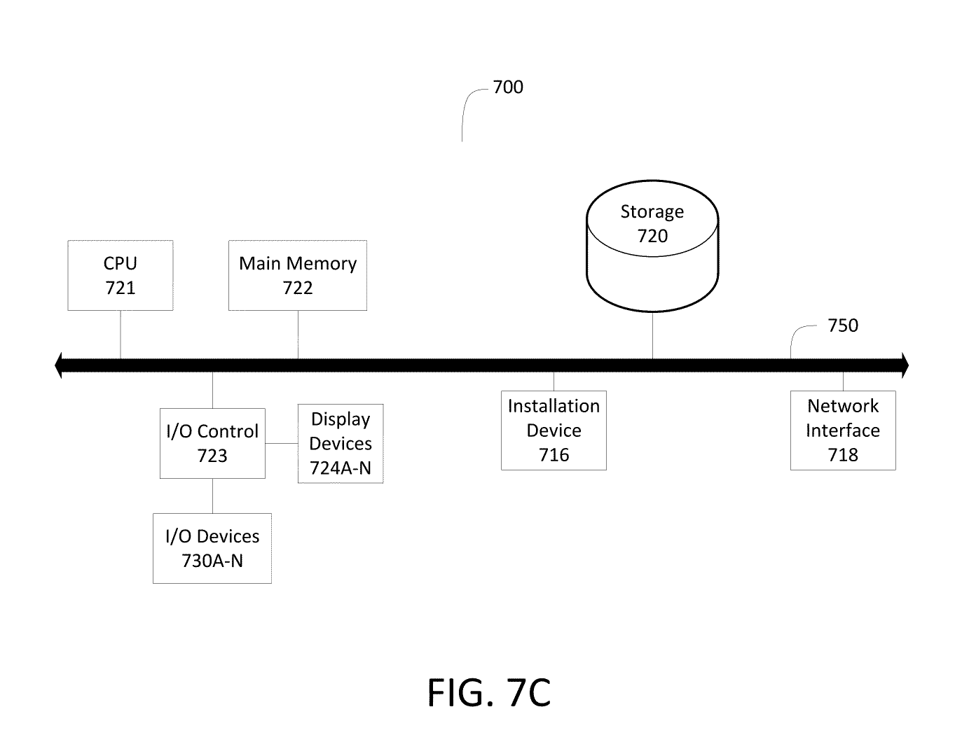

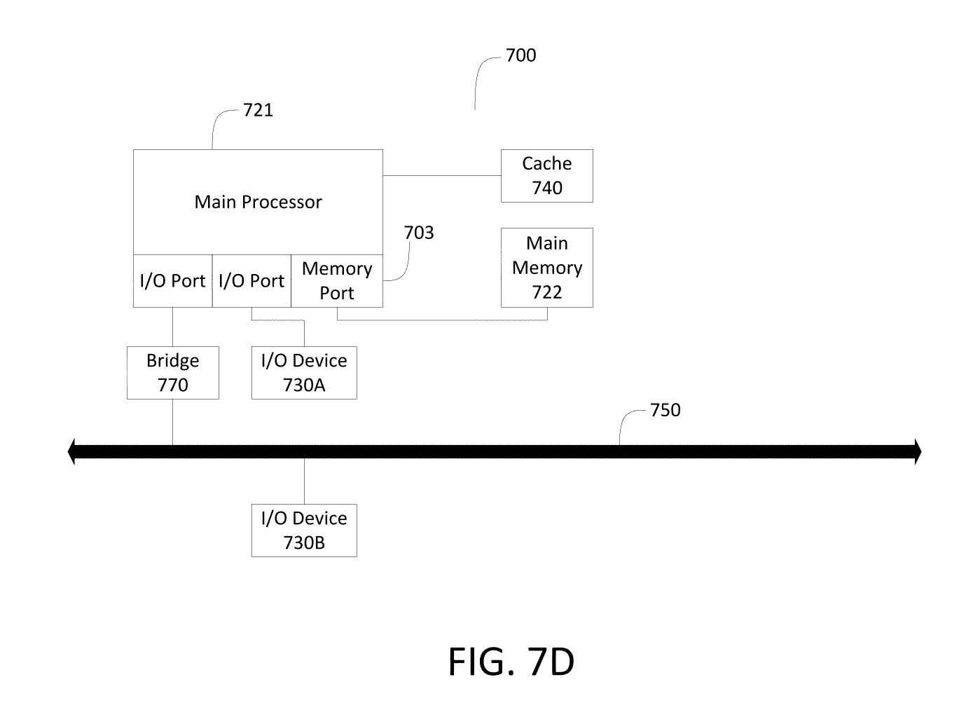

The communications unit 115 can connect the system 100 to a computer network, such as the Internet, local, wide, or other area networks, intranet, satellite network, or to other devices, described in further detail with the descriptions accompanying FIGS. 7A-7D. The communications unit 115 can connect the system 100 to a wireless local area network using Wi-Fi. The communications unit 115 can connect the system 100 to other devices via Bluetooth. The communications unit 115 can transmit data from processor 140 to the network. The communications unit 115 can also receive data from the network and relay the data to the processor 140. The communications unit 115 can include any radio antenna capable of allowing communication between the system 100 to a computer network, such as a patch antenna, microstrip antenna, or parabolic antenna.

The motion tracker 120 can detect the motion of the vehicle that the system 100 is located. The motion tracker 120 can include a gyroscope to detect the three dimensional orientation and rotation of the vehicle. The motion tracker 120 can include an accelerometer to measure the three dimensional acceleration of the vehicle. The motion tracker 120 can include a three dimensional compass to determine the direction of vehicle movement. The motion tracker 120 can be any motion tracking chip, such as the MPU-9150 MotionTracking Device. The motion tracker 120 can relay the orientation, rotation, acceleration, and movement direction information to the processor 140.

The locator unit 125 can determine the location of the vehicle that the system 100 is attached to. The locator unit 125 can include a GPS chip that can retrieve the location of the vehicle by accessing location information from GPS satellites. The locator unit 125 can retrieve location information of the vehicle by accessing location information from the communications unit 115. For example, when the communications unit 115 is connected to a local Wi-Fi network, the locator unit can access the location information of the network to retrieve location information about the vehicle.

The photo sensor 130 can detect the presence of an object in front of the photo sensor 130. For example, the photo sensor 130 can emit infrared light, and when the percentage of the light reflected back is above a predetermined threshold the photo sensor 130 can determine that an object is present in front of the photo sensor 130. The photo sensor 130 can determine the distance of an object in front of the photo sensor 130. For example, the photo sensor 130 can emit ultraviolet light, and the photo sensor 130 can determine the distance of the object by measuring the phase shift of the light reflected back. The photo sensor 130 can detect the presence of an object in front of the photo sensor 130 and then determine the distance of the object. The photo sensor 130 can emit a light and then detect the presence of another object or determine the distance of the object at predetermined intervals. For example, the photo sensor 130 can emit ultraviolet light every 2 to 15 minutes and based on the phase of the light reflected back detect whether an object is front of the photo sensor 130 and then determine the distance of the object. The photo sensor 130 can emit a light and then detect the presence of another object or determine its distance based on a condition precedent. For example, responsive to the determination by the photo sensor 130 that an object is present in front of the photo sensor 130, the photo sensor 130 can determine the distance of the object based on the measured the phase of the light reflected. The photo sensor 130 can relay the detection or the determination to the processor 140. The photo sensor 130 can relay the light reflection data to the processor 140 for the processor 140 to determine the presence and the distance of an object in front of the photo sensor 130.

The memory 135 can store data relayed from the various components in the system 100 through the processor 140. For example, the memory 135 can store content relayed from an external server via the communications unit 115 and the processor 140. The memory 135 can include a double data rate read-access memory (DDR) and an embedded multimedia card (eMMC). The DDR of the memory 135 can store short-term data and commands from the processor 140. The eMMC of the memory 135 can store long-term data, such as boot code, operating system, applications, content, and analytics data. The processor 140 can include at least one logic device and can comprise more than one processing unit. The processor 140 can process data relayed from and send data and commands to the various components in system 100. The processor 140 can receive images taken by the camera 105 and processed by the ISP 110. The processor 140 can relay commands and other signals to the camera 105 and ISP 110. For example, responsive to detecting an object in front of the photo sensor 130, the processor 104 can send a command to the camera 105 to take an image. The processor 140 can receive and transmit data through the communications unit 115. The processor 140 can receive orientation, rotation, acceleration, or movement direction information of the vehicle from the motion tracker 120. The processor 140 can receive location information from the locator unit 125. The processor 140 can receive light reflection data, detection or the distance from the photo sensor 130. The processor 140 can send control signals to the PWM 145 to control the front light pipe 150. The processor 140 can send the image to the mapper 150 to be rendered by the display 160. The processor 140 can be provided with power through the PMIC 165. The processor 140 can be a Texas Instruments OMAP3621 processor, a Marvel Armada 166 processor, or a FreeScale MX508 processor, or any other suitable processor.

The processor 140 or a vehicle location module executing on the processor 140 can receive or access vehicle location information of the vehicle that the system 100 is located. The processor 140 or the vehicle location module can receive or access vehicle location information via the communications unit 115. For example, when the communications unit 115 is connected to a Wi-Fi network, the processor 140 can determine the vehicle location information based on the data accessed from the Wi-Fi network via the communications unit 115. In addition, when the communications unit 115 is connected to a cellphone tower network, the processor 140 can determine the vehicle location information based on the location data of the cellphone tower communicated to the system 100 via the communications unit 115. The processor 140 or the vehicle location module can receive or access vehicle location information via the GPS unit 125. For example, when the GPS unit 125 is connected to a GPS satellite, the processor 140 can determine the vehicle location information based on the location coordinate data received from the GPS satellite.

The processor 140 or an interest point retrieval module executing on the processor 140 can retrieve proximate points of interest based on the vehicle location information. Points of interest can include a store, restaurant, theatres, landmarks, or any other location that may of interest or use. The processor 140 or the interest point retrieval module can retrieve or access the proximate points of interest based on the vehicle location information via the communications unit 115. For example, the processor 140 or the interest point retrieval module can transmit the vehicle location information via the communications unit 115 to an external server containing map data. In this example, the external server can send back to the processor 140 via the communication unit 115 all the points of interest within a certain radius (e.g., 5 miles) of the vehicle location information. The processor 140 or the interest point retrieval module can retrieve or access the proximate points of interest based on vehicle location information via memory 135. For example, responsive to a determination that the memory 135 has stored a map of the area around the vehicle location information, the processor 140 can retrieve points of interests within a certain radius around the vehicle location information from the memory 135. When retrieving these points of interest, the processor 140 can also retrieve location information of the points of interest and the distance from the vehicle location. For example, when retrieving a casual dining restaurant as a point of interest, the processor 140 can also retrieve the distance that the casual dining restaurant is away from the vehicle based on the vehicle location information. The processor 140 or the interest point retrieval module can also incorporate acceleration information in retrieving proximate points of interest. For example, if a vehicle is travelling north 40 miles per hour, the interest point retrieval module can transmit the vehicle location information via the communications unit 115 to the external server. The external server in turn can send back to the processor via the communications unit 115 all the points of interests within a certain radius (e.g., 3 mile) away from the vehicle's northbound path (e.g., for the next 5 miles)

The processor 140 or a time module executing on the processor 140 can retrieve time information. Time information can include hour, minute, second, date, season, parts of day (e.g., dawn or dusk), and the like. The processor 140 or the time module can retrieve time information from an internal clock. For example, the processor 140 or any one or more components of the system 100 can include a quartz clock, a digital counter incremented at a fixed frequency, or any other suitable timer used to determine time and date. The processor 140 or the time module can retrieve time information via the communications unit 115. For example, the processor 140 can transmit a request for time information to an external server that the system 100 is connected to via the communications unit 115. In this example, the external server can in turn send time information back to the processor 140 via the communications unit 115.

The processor 140 or a vehicle acceleration module executing on the processor 140 can determine vehicle acceleration information of the vehicle that the system 100 is attached to. The processor 140 or the vehicle acceleration module can retrieve or receive the vehicle acceleration information from the motion tracker 120. The processor 140 or the vehicle acceleration module can retrieve or receive the vehicle acceleration information from the motion tracker 120 at a predetermined interval. For example, the processor 140 can receive or retrieve vehicle acceleration data from the motion tracker 120 every 3 seconds to 20 minutes. The processor 140 or the vehicle acceleration module can retrieve the vehicle information from the motion tracker 120 based on a condition precedent. For example, responsive to the determination by the motion tracker 120 that the acceleration of the vehicle has changed past a predetermine threshold (e.g., 10 to 20 mph), the processor 140 can retrieve or receive the vehicle acceleration data from the motion tracker 120.

The processor 140 or a vehicle detection module can determine the relative velocity of another vehicle proximate to the vehicle that the system 100 is attached to. The processor 140 or the vehicle detection module can retrieve the relative velocity of the other vehicle from the photo sensor 130. For example, if the photo sensor 130 is placed at the back of the vehicle, responsive to detecting that there is a vehicle behind, the photo sensor 130 can measure the relative velocity of the other vehicle by measuring the phase shift in light reflected back from the object to the photo sensor 130. The processor 140 or the vehicle detection module can determine the relative velocity of the other vehicle from the photo sensor 130. For example, responsive to detecting an object such as the other vehicle in front of the photo sensor 130, the processor 140 can retrieve light reflection data from the photo sensor 130 and process the light reflection data to determine the relative velocity of the other vehicle detected. The processor 140 or the vehicle detection module can determine the relative velocity of the other vehicle via the camera 105 and the photo sensor 130. For example, responsive to detecting another object in front of the photo sensor 130, the processor 140 can process images taken by the camera 105 to determine the relative velocity of the other vehicle. The processor 140 can then apply object recognition techniques to determine the relative velocity of the other vehicle, such as edge detection, ridge detection, or corner detection algorithms. In this example, the processor 140 can measure the change in an edge features among the series of images to determine the relative velocity of the other vehicle.

The processor 140 or the vehicle detection module can determine the vehicle type information of the other vehicle proximate to the vehicle that the system 100 is attached to. Vehicle type information can include the make, model, color, or any other relevant information about a vehicle. The processor 140 or the vehicle detection module can determine the vehicle type information of the other vehicle by applying image recognition algorithms on images taken from the camera 105. For example, the processor 140 or the vehicle detection module can use a k-nearest neighbors algorithm on the images taken from the camera 105 to determine vehicle make and model. In this example, responsive to the photo sensor 130 detecting that there is another vehicle in front of the photo sensor 130, the processor 140 can send a command to the camera 105 to zoom in to take an image of the other vehicle. After having taken an image of the vehicle, the processor 140 can use a number of feature detection algorithms, such as scale-invariant feature transform (SIFT) and affine invariant feature detection algorithm, to determine the features in the image. An example of a feature or interest point in the image can include edges, corners, ridges, or boundaries. The processor 140 can then map the features of the image to an n-dimensional feature space. The processor 140 can also map the features of the images of other vehicles pre-stored in memory 135 or retrieved from an external server via the communications unit 115. There can be multiple images of other vehicle makes and models. Parameters used in the n-dimensional feature can include, for example, color, number of features, and types of features. The processor 140 can also use principal component analysis (PCA) or linear discriminant analysis (LDA) to reduce the number of dimensions for mapping features in the feature space. The processor 140 can then determine the distances of k nearest neighbors using a number of distance functions, such as Manhattan distance, Euclidean distance, Hamming distance, or Cosine distance. The processor 140 can determine the classifications of the features in the feature face based on the most common classification of the taken image feature's nearest neighbors. In this example, the processor 140 assign an initial test mean to the classification and then iterate through this algorithm until convergence. The processor 140 can determine convergence based on changes in classification or once the current mean is within a certain threshold (e.g., 1-15%) from the previous determination of the mean.

The processor 140 can then determine which vehicle make and model the other vehicle is based on the classification of the image taken by the camera 105. The processor 140 or the vehicle detection module can use other algorithms to determine the vehicle make and type, such as the scaling, k-means clustering, or any other image object recognition algorithms. The processor 140 or the vehicle detection module can determine the color of the other vehicle. For example, responsive to the photo sensor 130 detecting an object in front of the photo sensor 130, the processor 140 can send a command to the camera 105 to zoom into the vehicle and take an image of the other vehicle. The processor 140 can sample random points in the image to determine the color of the vehicle by taking the average of the red, blue, green values of the random sample points.

The processor 140 or the vehicle detection module can determine a matching score based on the meta data comparison of the features of other vehicles versus the features of the image of the vehicle taken from the camera 105. The meta data can include the make, model, and color of the vehicle. The meta data of vehicles can be pre-stored in memory 135 or retrieved from an external server via the communications unit 115. For example, once the processor 140 determines the meta data of the vehicle extracted from the image of the vehicle taken from the camera 105, the processor 140 can assign compare the meta data of the image versus the meta data of other vehicles using the nearest neighbor algorithm. The processor 140 can determine which vehicle the vehicle from the image taken from the camera 105 is based on the nearest neighbor algorithm.

The processor 140 or a content retrieval module executing on the processor can access or retrieve content. Content can also include any text, images, or animated images that depict advertisements about products or services, personal messages by a user of the system 100, or public service announcements. The processor 140 or the content retrieval module can access or retrieve content from an external server via the communications unit 115. The processor 140 or the content retrieval module can access or retrieve the content stored in the memory 135. The processor 140 or the content retrieval module can store the content retrieved or accessed from the external server via the communications unit 115 in the memory 135. The processor 140 or the content retrieval module can access, retrieve, or select content from an external server via the communications unit 115 based on a number of parameters. The parameters can include the vehicle location information, proximate points of interest information, time information, vehicle acceleration information, relative velocity of the other vehicle et cetera. The processor 140 can relay the content selected to the display 160 via the mapper 155.

The processor 140 or the content retrieval module can access, retrieve, or select content from the external server via the communications unit 115 based on the vehicle location information and proximate points of interest information. The processor 140 or the content retrieval module can access, retrieve, or select content via the communications unit 115 based on the vehicle location information and proximate points of interest information at a predetermined interval. For example, at every 30 seconds to 15 minutes, the processor 140 can send the vehicle location information and a request to an external server via the communications unit 115 for content. Responsive to the request, the external server can determine which points of interest are within a certain threshold radius (e.g., 5 miles) of the vehicle based on the vehicle location information, and send content back to the processor 140 via the communications unit 115. The processor 140 or content retrieval module can access, retrieve, or select content via the communications unit 115 based on the vehicle location information and proximate points of interest information based on a condition precedent. For example, responsive to the determination by the processor 140 via the GPS unit 125 that the vehicle has moved 2.5 miles in the past 15 minutes, the processor 140 can send the vehicle location information, proximate points of interest, and a request for content to the external server via the communications unit 115. In this example, the external server can select and send content corresponding to the proximate points of interest back to the processor 140 via the communications unit 115. The processor 140 or the content retrieval module can select the content accessed or retrieved based on vehicle location information for display in display 160.

The processor 140 or the content retrieval module can access, retrieve, or select content from the external server via the communications unit 115 based on the time information. For example, suppose the time information indicates that it is 9:15 am on a Saturday. The processor 140 can select one of the content received from the external server via the communications unit 115 that is stored in memory 135 based on this time information, such as a brunch dining restaurant or coffee shop. The processor 140 can also send the time information and a request to the external server via the communications unit 115 to retrieve or access content based on the time information. The processor 140 or the content retrieval module can select the content accessed or retrieved based on time information for display in display 160.

The processor 140 or the content retrieval module can access, retrieve, or select content from the external server via the communications unit 115 based on the vehicle acceleration information of the vehicle. For example, the content retrieval module can send the vehicle acceleration information and vehicle location information to the external server via the communications unit 115. If the vehicle acceleration information indicates that the vehicle is heading northbound, the external server can send content related to points of interest in locations north of the vehicle to the processor 140 via the communications unit 115. The processor 140 or the content retrieval module can select the content accessed or retrieved based on vehicle acceleration information for display in display 160.

The processor 140 or the content retrieval module can also vary or alter content retrieved or accessed from the external server via the communications unit 115 based on the vehicle acceleration information. For example, suppose the content is regarding a brand name shoe. The content at 5 mph, for example, can include more details, such as sales at nearby shoe stores or details regarding the shoe, since passersby can read such detail on the display 160 at lower speeds. Continuing the example, the content at 45 mph can be changed to only include the trademark of the brand name shoe or the name of the shoe, since the audience of the content may not be able to read detailed text or images in the content at higher speeds. The processor 140 or the content retrieval module can select the content varied or altered based on vehicle acceleration information for display in display 160.

The processor 140, the content retrieval module, or a prioritization module executing on the processor 140 can prioritize content retrieved or accessed from the external server via the communications unit 115 based on vehicle location information, proximate points of interest information, time information, or vehicle acceleration information. For example, the prioritization module can assign a greater weight for content retrieved based on vehicle location information and proximate points of interest information. In this example, suppose that the proximate points of interest information indicates that there multiple stores located within a 5 mile radius around the vehicle. The prioritization module can assign greater weights to the stores closer to the path of the vehicle indicated by the acceleration information than those farther from the path. The processor 140 or the content retrieval module can select the content with the highest weight or priority for display in display 160.

The processor 140 or prioritization module can prioritize content retrieve or accessed from the external server via the communication unit 115 based in part on a content auction process. The content auction can be carried out in an online portal, for example, hosted on an external server. Advertisers or other content offerors can place a bid, specifying content bid price, target audience, target geography, target time, and topic category. The external server or the processor 140 can limit the content to select based on the target audience, target geography, target time and topic category. For example, if a content offeror has specified that the target geography is along a main street in Los Angeles, the external server will not select the content if the received vehicle location information indicates that the system 100 and the associated vehicle is located in Irvine. The external server can receive or store the content offerors' content bid prices, target audience, target geography, target time, and topic category. The target geography can include microsegmented geographic zones. The external server can determine the market or going rate. The external server can allow the offeror to place a content bid price at the market rate or higher. The processor 140 or prioritization module can assign content associated with a higher content bid price with a higher priority. For example, suppose two content accessed by the processor 140 are associated with two respective content offerors place a bid specifying same or similar target audience, target geography, target time, and topic category, but one has a higher content bid price than the other. In this example, the processor 140 can assign a higher weight on the content of the offeror with the higher content bid price.

The processor 140 or prioritization module can also estimate the conversion rate for the content based on the vehicle location information, proximate points of interest information, time information, vehicle acceleration information, and content bid prices. The processor 140 or prioritization module can retrieve or access the content bid prices from an external server via the communications unit 115. For example, suppose the time information indicated that the date was December and the proximate points of interest included a skating rink and a swimming pool. In this example, the processor 140 can estimate conversion rate of a skating rink as being greater than a swimming pool based on the contextual time location and vehicle location information. The processor 140 can also assign weights to the vehicle location information, proximate points of interest information, time information, vehicle acceleration information, and content bid prices in determining the conversion rate. For example, suppose the time information indicated that the date was July and the proximate points of interest included an ice cream store and a Japanese ramen restaurant. In this example, if the content bid prices were greater for the ice cream store, the processor 140 can assign a greater weight to the ice cream store than the ramen restaurant. The processor 140 or the content retrieval module can select the content with the highest estimated conversion rate for display in display 160.

The processor 140 or the prioritization module can prioritize content retrieved or accessed from the external server via the communications unit 115 based on type of content. For example, suppose the content accessed or retrieved is a public service announcement indicating a potential terrorist threat and warning the public to avoid certain areas near the vehicle based on the vehicle location. Other public service announcement can include AMBER alerts, weather warnings, crime reports, and the like. In this example, the prioritization module can automatically assign the public service announcement with the highest priority and select the public service announcement for display. The processor 140 or the prioritization module can prioritize content retrieve or accessed from the external server via the communications unit 115 based on the preferences indicated by the administrator. For example, the administrator of the system 100 can set the weights assigned by the prioritization module such that 60% of the content accessed, retrieved, or selected by the processor 140 is commercial, 40% are public service announcements. In this example, the processor 140 can select content to match the distribution set by the administrator. The processor 140 or the content retrieval module can select the content with the highest priority for display in display 160.

The processor 140 or the content retrieval module can access, retrieve, or select content based on the vehicle type information. The processor 140 or the content retrieval module can access, retrieve, or select content from the external server via the communications unit 115 based on the vehicle type information. For example, responsive to the determination by the vehicle detection module that the trailing vehicle is a Toyota Prius, the processor 140 can send the vehicle type information and vehicle location information to an external server via the communications unit 115. The external server can send, for example, content related to Toyota dealerships within 20 miles of the vehicle based on the vehicle location information back to the processor 140 via the communications unit 115. The processor 140 or the content retrieval module can select content retrieved or accessed from the external server via the communications unit 115 based on the vehicle type information. For example, responsive to the determination by the vehicle detection module that the trailing vehicle is a blue Honda Civic, the content retrieval module can select content stored in the memory 135 regarding a trade in special a local car dealership. The processor 140 or the content retrieval module can select the content based on the vehicle type information for display in display 160.

The processor 140 or the content retrieval module can access, retrieve, or select content based on the location information, time information, vehicle type information associated in the persona database. The persona database can be stored at an external server. The processor 140 can access or retrieve data from the persona database via the communications unit 115. The persona database can contain demographics information that is dynamically updated and maintained. The processor 140 or the content retrieval module can query demographics information based on location information, time information, and vehicle type information. The demographics information can include vehicle type information, location information, time information, and content that is associated with the vehicle type information, location information, and time information. The persona database can associate content with the vehicle information, the location information, and the time information. The processor 140 or the content retrieval module can select content based on the demographics information stored in the persona database. For example, suppose the processor 140 determines that the vehicle information indicates that the vehicle is a Fiat 500L, the location information indicates that the vehicle is in New York City, and the time information indicates that the time is June in the evening during rush hour. In this example, based on the vehicle location information, location information, and time information, and the associated demographics, the processor 140 select content about summer vacation spots in upstate New York.

The processor 140 or the content retrieval module can access, retrieve, or select content based on the relative velocity of the other vehicle. The processor 140 or the content retrieval module can access, retrieve, or select content from an external server via the communications unit 115 based on the relative velocity of the other vehicle. For example, responsive to the detection by the photo sensor 130 that another vehicle is trailing the vehicle that the system 100 is attached to, the processor 140 can send the relative velocity data to an external server via the communications unit 115. The external server can then in turn send content back to the processor 140 via the communications unit 115 that can be suitable for reading at such relative velocities. For example, at higher relative velocities, content containing larger font or labels may be more suitable for reading by the audience. In contrast, at lower relative frequencies, content containing smaller font or labels can be read by the passersby. The processor 140 or the content retrieval module can also alter or vary content based on the relative velocity of the other vehicle. For example, the content retrieval module can alter content retrieved or accessed from the external server via the communications unit 115 stored in the memory 135. Responsive to the determination by the vehicle detection module that the relative velocity is increasing, the content retrieval module can enlarge the logo of a content and remove text from the content. The processor 140 or the content retrieval module can select the content based on the relative velocity of the other vehicle for display in display 160.

The processor 140 or a content trail module executing on the processor 140 can store the vehicle location information and the associated content. The processor 140 or the content trail module executing on the processor 140 can store the vehicle location information and the associated content in the memory 135. The processor 140 or the content trail module, responsive to a request from an electronic media device (e.g., a smartphone, tablet, or laptop), can send to the electronic media device the content that was selected at the vehicle location information proximate to the location of the electronic media device (e.g., 1-5 miles). The processor 140 or the content trail module executing on the processor 140 can store the vehicle location information and the associated content to an external server such as one in the cloud via the communications unit 115. The external server, responsive to a request from an electronic media device, can send to the electronic media device the content that was selected at the vehicle location information nearest to the location of the electronic media device.

The processor 140 or the content trail module can communicate with the electronic media device via communications unit 115. The processor 140 or the content trail module can determine whether an electronic media device when the processor 140 is connected to the Wi-Fi or Bluetooth with the electronic media device via the communications unit 115. The processor 140 can turn off either the Wi-Fi or Bluetooth communications in the communications unit 115 based on which connection the electronic media device is using, thereby conserving power from the battery 180 and allowing longer runtime for operation the system 100. For example, the processor 140 can turn off the Wi-Fi, when the processor 140 determines that the electronic media device is connected to the system 100 via Bluetooth. The electronic media device and the system 100 can transfer data between each other.

The processor 140 or a content orchestration module executing on the processor 140 can orchestrate the accessing, retrieving, or selecting of content with another system 100 attached to another vehicle. For example, the content selected across multiple systems 100 can be such that content displayed on each display is in a coherent manner, such as staggering the content display or displaying various frames of the content in delayed sequence. The processor 140 or content orchestration module can retrieve or access the status of another system 100 attached to another vehicle. The processor 140 or content orchestration module can retrieve or access the status of another system 100 attached to another vehicle from an external server via the communications unit 115. For example, the processor 140 or content orchestration module can send the vehicle location information and a request for a status of another vehicle with the system 100 to an external server via the communications unit 115. The external server in turn can send the status of other vehicle to the processor 140 via the communications unit 115. Responsive to the status of the other vehicle, the processor 140 can access, retrieve, or select content that has been accessed, retrieved, or selected by the other vehicle. The external server can also orchestrate the content accessed, retrieved, or selected by the processor 140. For example, responsive to the determination that there are multiple vehicles with the system 100 attached within a certain threshold distance, the external server can send related content to the systems 100 of these multiple vehicles. The external server can also orchestrate the content accessed, retrieved, or selected by the processor based on a campaign rule. The campaign rule can include which content should be accessed, retrieved, or selected based on the vehicle type information, location information, time information, vehicle acceleration information, proximate points of interest, proximate car data, et cetera. For example, a campaign rule can specify that all systems 100 that are attached to minivans on a given street in a major metropolitan city select a particular content. In this example, upon determining that a vehicle has met the specifications of the campaign rule, the processor 140 can retrieve the particular content from the external server via communications unit 115 in accordance with the campaign rule.

The PWM unit 145 can translate or map commands from the processor 140 to activate the front light pipe 150. The PWM unit 145 can translate or map commands from the processor 140 to control illumination by the front light pipe 150. The front light pipe 150 can be integrated with the display 160 to disperse light and illuminate the display 160. The mapper 155 can translate or map the pre-rendered images of the content from the processor 140 to a format compatible with the electrophoretic display 160. The mapper 155 can control which encapsulations in the electrophoretic display 160 to activate based on the colors in the pre-rendered image. For example, suppose the pre-rendered image is a black square in the middle of a white background. The mapper 155 can then activate the proportionate area of the display 160 corresponding to the pixels that are black in the pre-rendered image to black. The PWM unit 145 and the mapper 155 can be incorporated into the processor 140.

The processor 140 or an impression verification module executing on the processor 140 can confirm whether the display 160 has displayed the content. The processor 140 or an impression verification module can take a screenshot of the display 160. The processor 160 can then compare the screenshot to the image of the content using a number of image recognition techniques. For example, the processor 160 can execute scale the image and screenshot down to lower resolution and compute the difference of the grayscale per pixel. In this example, if the total difference is above a certain threshold (e.g., 2-8%), the processor 160 can determine that the image and screenshot are different and that the display 160 has not properly displayed the content.

The PMIC 165 can manage the power flowing from the charge port 175, battery 180, and solar controller 185 to the processor 140. The PMIC 165 can provide the processor 140 with clock and multiple internal voltages. The PMIC 165 can be a Texas Instrument TPS65921, Texas Instrument 603B107, Freescale MC34708 chips, or any PMIC chip or component appropriate for managing power to the processor 140. The functionality of the PMIC 165 can be incorporated into the processor 140. In addition, the system 100 can omit the PMIC 165 and have the processor 140 directly connected to the charger unit 170.

The charger unit 170 can charge the battery 180. The charger unit 170 can also manage the power flowing from the charge port 175, battery 180, and solar controller 185 to the PMIC 165. The charger unit 170 can manage power flower from the charge port 175 or solar controller 185 to the battery 180. The charger unit 170 can be the Texas Instrument BQ24073 chip, or any other chip or device suitable for managing power flow or charging the battery 180.

The charge port 175 can receive power from an external power source and relay the power to a charger 155. The charge port 175 can connect the system 100 to an external power source. The charge port 175 can be a universal serial bus (USB), a female end of a three prong electrical plug, a female end of a two end electrical plug, a sleeve coupler, an ISO 4165 double pole connector, or any other electrical connector suitable to charge the various components of system 100. The external power source can be the cigarette lighter receptacle in a vehicle, an external battery placed inside the vehicle, an inverter placed within the vehicle, or any other power source suitable to provide electricity to the various components of system 100.

The battery 180 can provide power to the various components of system 100. The battery can provide power directly to the processor bypassing the PMIC 165. The battery can be a primary battery, such as a zinc-carbon battery, alkaline battery, or any other battery capable of providing power to the various components of system 100. The battery can be rechargeable, receiving power from the charge port 175 or solar controller 185 via the charger 170. Such a battery can be a lithium-ion battery, nickel-cadmium battery, nickel-zinc battery, nickel metal hydride battery, or any battery capable of being recharged and providing power to the various components of system 100.

The solar controller 185 can be connected to a solar panel. The solar panel can be any photovoltaic cell capable of converting light into electricity, such as a crystalline silicon solar cell, thin film solar cell, or organic solar cell. The solar controller 185 can connect the system 100 to a solar panel affixed to the outside of the vehicle. The solar controller 185 can control the rate at which electrical current is added to the system 100 from the solar panel. The solar controller 185 can control the rate at which electrical current or voltage is added to the system 100 from the solar panel to prevent damage to the battery 180 from overcharging. The solar controller 185 can control the rate at which electrical current or voltage is added to the system 100 from the solar panel to prevent damage to the various components of system 100 from overcharging.

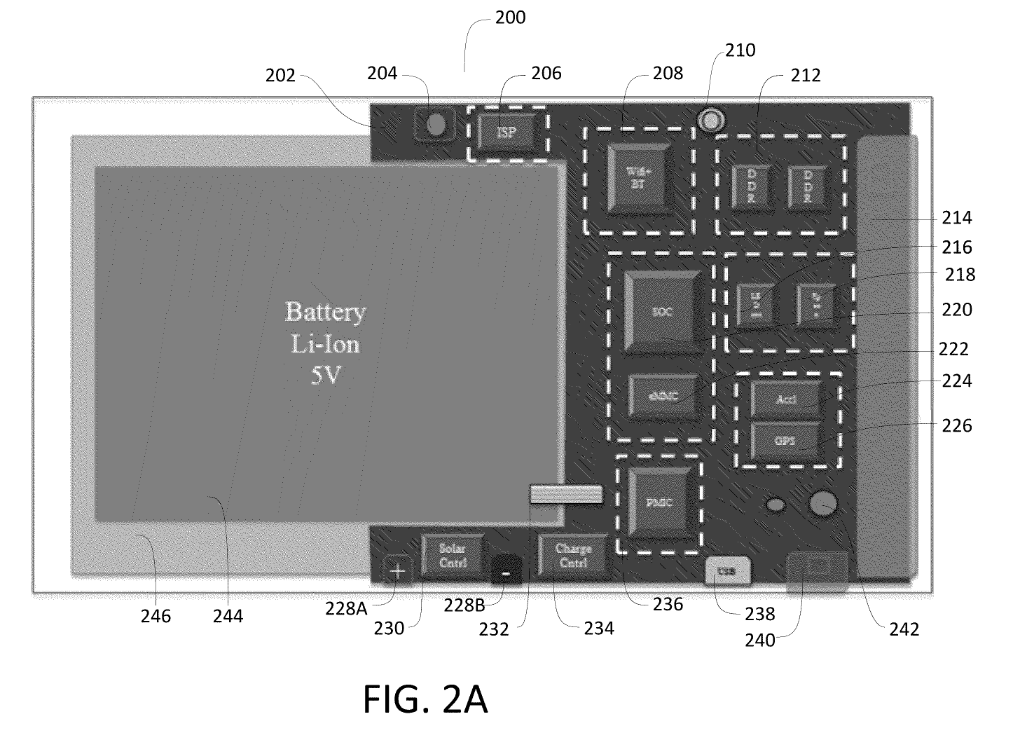

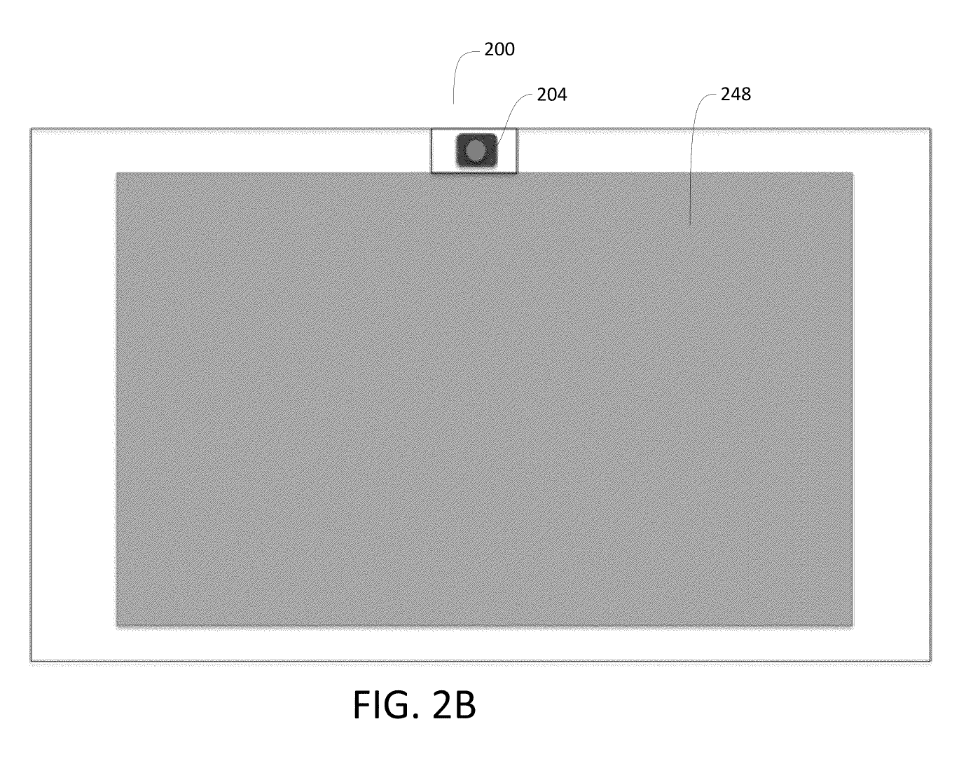

FIG. 2A and 2B depict the front and backside of the physical layout of the system 100, according to an illustrative implementation. The device 200 can include a printed circuit board 202 that has a camera 204, image signal processor (ISP) 206, a communications chip with Wi-Fi and Bluetooth capability 208, chip antenna 210, two double data rate read-access memory (DDR) 212, electrophoretic display connector 214, mapper chip 216, pulse width modulator (PWM) chip 218, system-on-a-chip (SOC) 220, embedded multimedia card (eMMC) 222, accelerometer chip 224, GPS chip 226, positive terminal to the solar panel 228A, negative terminal to the solar panel 228B, solar controller 230, battery connector 232, charge controller 234, power management integrate circuit 236, USB port 238, front light pipe connector 240, and multifunction button 242. The device 200 can also include a 5V lithium-ion battery 244, front light pipe 246, and electrophoretic display 248. The multifunction button 242 can be used to initialize the configuration of the device 200. For example, the multifunction button 242 can be used as a joystick to enter information about an electronic media device, such as smart phone, to connect the electronic media device to the device 200. The depiction of the various components FIG. 2A and 2B are for illustrative purposes, as these components can be implemented, for example, on an integrated circuit or on multiple PCBs.

The various components depicted in FIG. 2A and 2B can be understood in relation to FIG. 1 and the description above concerning the various components in the device 200. For example, the camera 204 can correspond to the camera 105. The ISP 206 can correspond to the ISP 110. The Wi-Fi and Bluetooth chip 208 and chip antenna 210 can correspond to the communications unit 115. DDR 212 and eMMC 220 can correspond to memory 135. The electrophoretic display connector 241 can correspond to the connection between the mapper 155 to the display 160. Mapper 216 and pulse width modulator chips 218 can correspond to PWM unit 145 and mapper 155 respectively. The SOC 220 can correspond to the processor 140. The accelerometer chip 222 can correspond to the motion tracker 120. The GPS chip 224 can correspond to the GPS unit 125. The PMIC 236 can correspond to PMIC 165. The solar controller 230 can correspond to the solar controller 185. The battery connector 232 can correspond to the connection between the charger 170 and the battery 180. The charge controller 234 can correspond to the charger 170. The USB port 238 can correspond to the charge port 175. The front light connector 240 can correspond to the connection from the PWM unit 145 to the front light pipe 150. The 5V Li-Ion battery 244 can correspond to the battery 180. The front light 246 can correspond to the front light pipe 150. The electrophoretic display 248 can correspond to the display 160.

Various components of the PCB 202 can be coupled via conductive tracks, laminated circuits, pads, or vias (not shown in FIG. 2). For example, the camera 204 can be coupled to the ISP 206. The ISP 206 can be coupled to the SOC 218. The Wi-Fi and Bluetooth chip 208 can be coupled to the SOC 218 and chip antenna 210. The chip antenna 210 can be coupled to the Wi-Fi and Bluetooth chip 208. The DDR 212 can be coupled to the SOC 218. The electrophoretic display connector 214 can be coupled to the mapper chip 218 and to the electrophoretic display 246. The mapper 216 can be coupled between the SOC 220 and the electrophoretic connector 214. The PWM chip 218 can be coupled between the SOC 220 and the electrophoretic connector 214. The eMMC 222 can be coupled to the SOC 220. The accelerometer chip 224 can be coupled to the SOC 220. The GPS chip 226 can be coupled to the SOC 220. The positive terminal and negative terminals 228A and 228B can be coupled between the solar panel and the solar controller 230. The charge control 234 can be coupled to the USB port 238, solar controller 230, 5V Li-Ion battery 244, and the PMIC 236. The PMIC 236 can be coupled between the charge control 234 and the SOC 220. The USB port 238 can be coupled toe the charge control 234. The front light pipe connector 240 can be coupled between the PWM chip 218 and the front light pipe 246. The multifunction button 242 can be coupled to the SOC 220.

The device 200 can also include an electromagnetic interference (EMI) shield to cover and protect the various components of the PCB 202 from EMI. The EMI shield can include sheet metal, metal foam, metal screen, metal mesh, or any suitable material to enclose and protect the various components of the PCB 202 from EMI. The EMI shield can cover one or a few components, as indicated by the dotted lines in FIG. 2. The EMI shield can also cover multiple components outside the dotted lines. For example, there can be one EMI shield can cover Wi-Fi and Bluetooth chip 208, DDR 212, SOC 216, and eMMC 222. In addition, the device 200 can include a ground for the EMI shield, placed anywhere along the PCB 202.

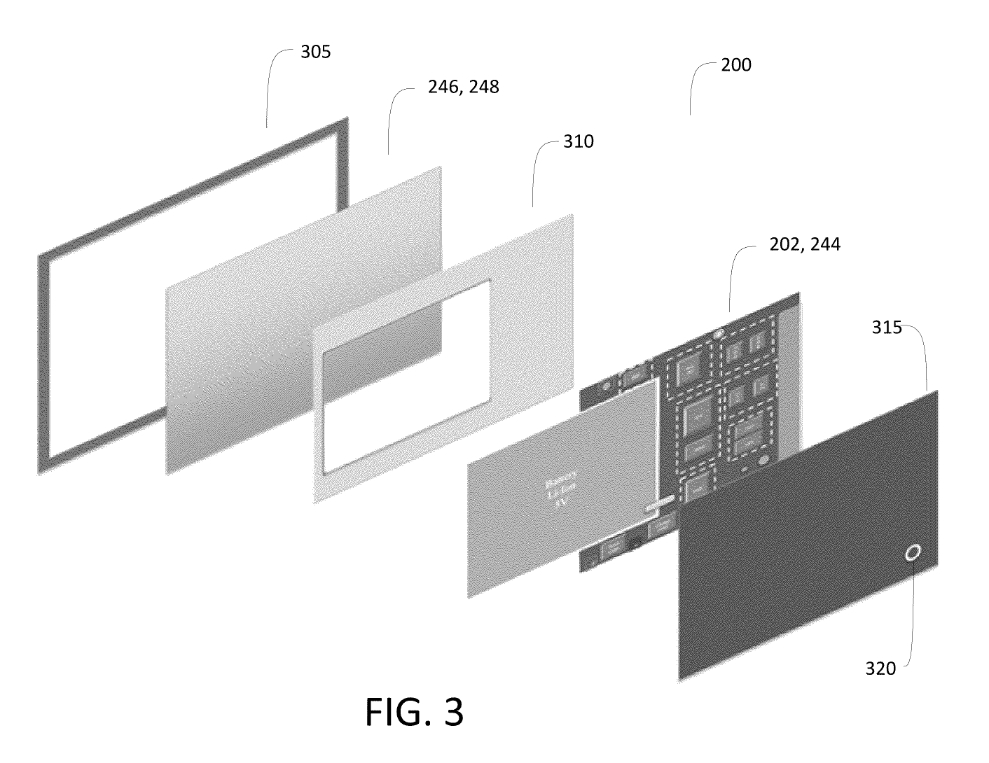

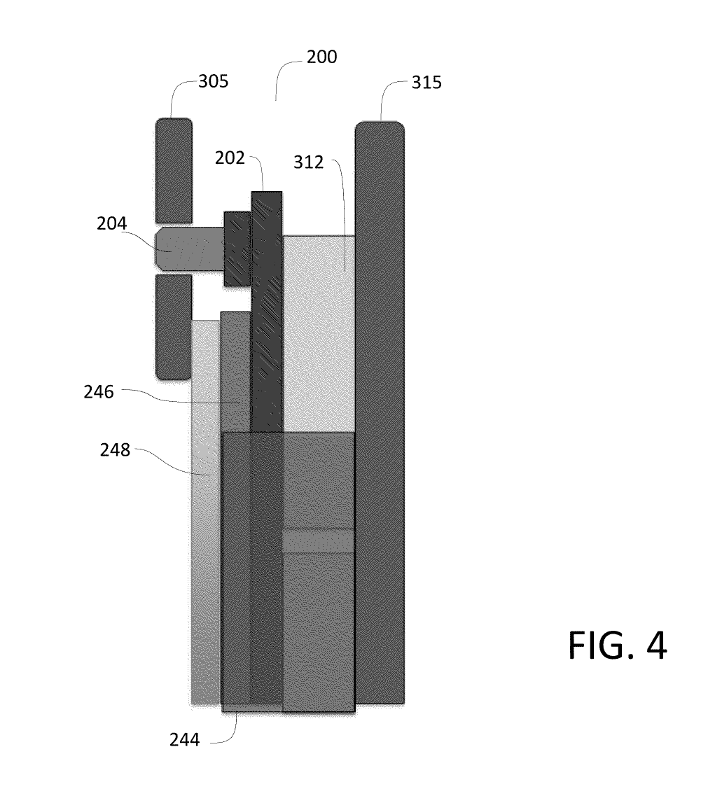

FIGS. 3 and 4 depict the physical layers of the device 200 for displaying content from a vehicle, according to an illustrative implementation. FIG. 3 depicts an obliqueview the physical layers of the device 200 for display content from a vehicle, according to an illustrative implementation. The layers of the device 200 can include a front bevel 305, electrophoretic display 246 with front light pipe 248, plate 310, PCB 202 with the 5V Li-Ion battery 244, backing 312, and rear plate 315. The front bevel 305 can be used to hold the electrophoretic display 246 and the front light pipe 248. The front bevel 305 can be made of plastic, metal, wood, composites, or any material suitable to hold in the device 200. The front bevel 305 can be connected to the front light pipe 248 to direct so that light from the back of the device is diverted to the front bevel 305. The plate 310 can be used to hold and support the 5V Li-Ion battery 244. The backing 310 can function as a support between the PCB 202 and the electrophoretic display 246 and front light pipe 248. The plate 310 can be in contact with the backing 312 (shown in detail in FIG. 4) to transfer heat from the electrophoretic display 246. The plate 310 and backing 312 can be made of plastic, metal such as aluminum, wood, composites, or any other material suitable to hold the 5V Li-Ion battery 244. The backing 310 can dissipate heat from the device 200. The backing 312 can be thermally coupled to the other layers in the device 200. The backing 312 can be a Peltier cooler, used to cool the device 200 via temperature differential. The backing 312 can generate electricity for the battery or drive a heat pump in the device 200. The backing 312 can be connected to a thermostat that determines whether to use the backing 200 to generate electricity or drive the heat pump. The rear 315 can hold and support the PCB 202 and 5V Li-Ion battery 244 to the backing 312. The rear 315 can include a small button or opening 320 for the multifunction button 242. The rear 315 can be made of plastic, metal, wood, composite, or any material suitable to hold in the device 200. The rear 315 can be thermally coupled to the other layers in the device 200. The rear 315 can include a fin structure to dissipate heat.

FIG. 4 depicts a side view of the physical layers of the device 200 for displaying content from a vehicle, according to an illustrative implementation. The side view of the layers of the device 200 include the front bevel 305, electrophoretic display 248, front light pipe 246, camera 204, PCB 202, battery 244, backing 310, and rear 315. The camera 204 can be placed in an opening on the front bevel 305. The electrophoretic display 248 can be placed between the front light pipe 246 and the front bevel 305. The front light pipe 246 can be placed between the electrophoretic display 248 and PCB 202, and be overlapping with the battery 244. The PCB 202 can be placed between the front light pipe 246 and the backing 310, and be in the same overlapping plane as the battery 244. The backing 310 can be placed between the PCB 202 and the rear 315, and be in the same overlapping plane as the battery 244. The thickness of the front bevel 305 can range between 0.8 mm to 2 mm. The thickness of the electrophoretic display can range between 0.8 mm to 1.5 mm. The thickness of the plate 310 can range between 0.7 mm to 1.0 mm. The thickness of the backing 312 can range between 0.7 mm to 1.0 mm. The thickness of the PCB 202 can range between 1 mm to 4 mm. The thickness of the battery 244 can range between 3 mm to 7 mm.

The device 200 or the system 100 can be placed anywhere in a vehicle. A vehicle can include any sedan car, bus, truck, station wagon, van, motorcycle, or any other motorized vehicle. A vehicle can also include non-motorized vehicles, such as rickshaws, bicycles, and tricycles. The placement of the device 200 can vary. If the vehicle is a sedan car, the device 200 can be placed, for example, along the back window of the vehicle with the electrophoretic display 248 side of the device 200 facing out the window. The device 200 can be also placed along a side window of the vehicle with the electrophoretic display 248 side of the device 200 facing out the respective window. If the vehicle is a bus, device 200 can be placed along the back side of the bus below the back window. If the vehicle is a motorcycle, the device 200 can be placed on the back seat support with the electrophoretic display 248 side of the device 200 facing back.

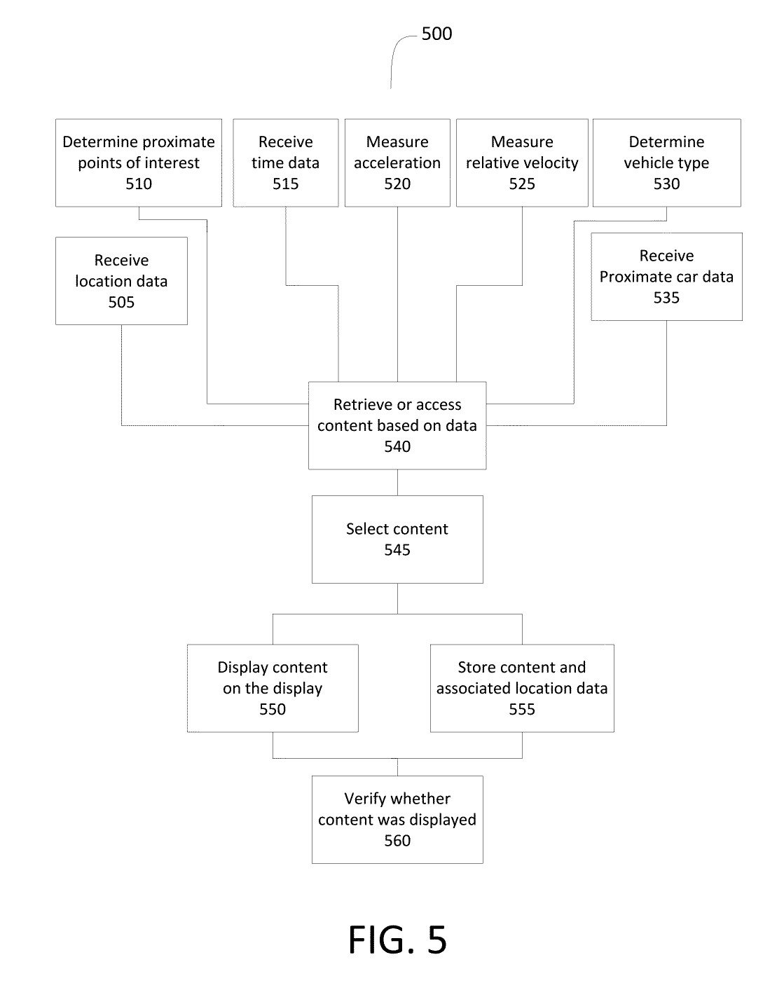

FIG. 5 is an illustration of a method or workflow 500 for displaying content from a vehicle. The workflow 500 can be performed or executed by the processor 140 in computing system 100. The workflow 500 can be performed or executed at predetermined time intervals or based on a condition precedent. For example, responsive to the determination that the vehicle has moved 5 miles from when the processor 140 previous executed workflow 500, the processor 140 can execute workflow 500.

The computing system 100 can receive or access location data (ACT 505). The computing system 100 can receive or access vehicle location data via a communications unit 115. For example, when the communications unit 115 is connected to a Wi-Fi network, the computing system 100 can determine the vehicle location information based on the data accessed from the Wi-Fi network via the communications unit 115. In addition, when the communications unit 115 is connected to a cellphone tower network, the computing system 100 can determine the vehicle location information based on the location data of the cellphone tower communicated to the system 100 via the communications unit 115. The computing system 100 can receive or access vehicle location information via the GPS unit 125. For example, when the GPS unit 125 is connected to a GPS satellite, the computing system 100 can determine the vehicle location information based on the location coordinate data received from the GPS satellite.

The computing system 100 can determine proximate points of interest (ACT 510). The computing system 100, the vehicle location module, or the proximate points retrieval module can retrieve or access the proximate points of interest based on the vehicle location information via the communications unit 115. For example, the computing system 100 can transmit the vehicle location information via the communications unit 115 to an external server containing map data. In this example, the external server can send back to the computing system 100 via the communication unit 115 all the points of interest within a certain radius (e.g., 10 miles) of the vehicle location information. The computing system 100 can retrieve or access the proximate points of interest based on vehicle location information via memory 135. For example, responsive to a determination that the memory 135 has stored a map of the area around the vehicle location information, the computing system 100 can retrieve points of interests within a certain radius (e.g., 8 miles) around the vehicle location information from the memory 135. When retrieving these points of interest, the computing system 100 can also retrieve location information of the points of interest and the distance from the vehicle location. For example, when retrieving a casual dining restaurant as a point of interest, the computing system 100 can also retrieve the distance that the casual dining restaurant is away from the vehicle based on the vehicle location information.

The computing system 100 can receive or access time data (ACT 515). The computing system 100 or a time module executing on the computing system 100 can retrieve or access time data. The computing system 100 can retrieve time information from an internal clock. For example, the computing system 100 or any one or more components of the system 100 can include a quartz clock, a digital counter incremented at a fixed frequency, or any other suitable timer used to determine time and date. The computing system 100 or the time module can retrieve time information via the communications unit 115. For example, the computing system 100 can transmit a request for time information to an external server that the system 100 is connected to via the communications unit 115. In this example, the external server can in turn send time information back to the computing system 100 via the communications unit 115.

The computing system 100 can measure acceleration data (ACT 520). The computing system 100 or a vehicle acceleration module executing on the computing system 100 can determine vehicle acceleration data of the vehicle that the system 100 is attached to. The computing system 100 can retrieve or receive the vehicle acceleration information from the motion tracker 120. The computing system 100 can retrieve or receive the vehicle acceleration information from the motion tracker 120 at a predetermined interval. For example, the computing system 100 can receive or retrieve vehicle acceleration data from the motion tracker 120 every 3 seconds to 20 minutes. The computing system 100 can retrieve the vehicle information from the motion tracker 120 based on a condition precedent. For example, responsive to the determination by the motion tracker 120 that the acceleration of the vehicle has changed past a predetermine threshold (e.g., 10 to 20 mph), the computing system 100 can retrieve or receive the vehicle acceleration data from the motion tracker 120.

The computing system 100 can determine relative velocity of another vehicle (ACT 525). The computing system 100 or a vehicle detection module can determine the relative velocity of another vehicle proximate to the vehicle that the system 100 is attached to. The computing system 100 can retrieve the relative velocity of the other vehicle from the photo sensor 130. For example, if the photo sensor 130 is placed at the back of the vehicle, responsive to detecting that there is a vehicle behind, the photo sensor 130 can measure the relative velocity of the other vehicle by measuring the phase shift in light reflected back from the object to the photo sensor 130. The computing system 100 can determine the relative velocity of the other vehicle from the photo sensor 130. For example, responsive to detecting an object such as the other vehicle in front of the photo sensor 130, the computing system 100 can retrieve light reflection data from the photo sensor 130 and process the light reflection data to determine the relative velocity of the other vehicle detected. The computing system 100 can determine the relative velocity of the other vehicle via the camera 105 and the photo sensor 130. For example, responsive to detecting another object in front of the photo sensor 130, the computing system 100 can process images taken by the camera 105 to determine the relative velocity of the other vehicle. The computing system 100 can then apply object recognition techniques to determine the relative velocity of the other vehicle, such as edge detection, ridge detection, or corner detection algorithms. In this example, the computing system 100 can measure the change in an edge features among the series of images to determine the relative velocity of the other vehicle.

The computing system 100 can determine vehicle type (ACT 530). The computing system 100 or a vehicle detection module executing on the computing system 100 can determine the vehicle type data of the other vehicle proximate to the vehicle that the system 100 is attached to. The computing system 100 can determine the vehicle type information of the other vehicle by applying image recognition algorithms on images taken from the camera 105. For example, the computing system 100 can use a k-nearest neighbors algorithm on the images taken from the camera 105 to determine vehicle make and model. In this example, responsive to the photo sensor 130 detecting that there is another vehicle in front of the photo sensor 130, the computing system 100 can send a command to the camera 105 to zoom into take the other vehicle. After having taken an image of the vehicle, the computing system 100 can use a number of feature detection algorithms, such as scale-invariant feature transform (SIFT) and affine invariant feature detection algorithm, to determine the features in the image. An example of a feature or interest point in the image can include edges, corners, ridges, or boundaries. The computing system 100 can then map the features of the image to an n-dimensional feature space. The computing system 100 can also map the features of the images of other vehicles pre-stored in memory 135 or retrieved from an external server via the communications unit 115. There can be multiple images of other vehicle makes and models. Parameters used in the n-dimensional feature can include, for example, color, number of features, and types of features. The computing system 100 can also use principal component analysis (PCA) or linear discriminant analysis (LDA) to reduce the number of dimensions for mapping features in the feature space. The computing system 100 can then determine the distances of k nearest neighbors using a number of distance functions, such as Manhattan distance, Euclidean distance, Hamming distance, or Cosine distance. The computing system 100 can determine the classifications of the features in the feature face based on the most common classification of the taken image feature's nearest neighbors. In this example, the computing system 100 assign an initial test mean to the classification and then iterate through this algorithm until convergence. The computing system 100 can determine convergence based on changes in classification or once the current mean is within a certain threshold (e.g., 1-15%) from the previous determination of the mean.

The computing system 100 can then determine which vehicle make and model the other vehicle is based on the classification of the image taken by the camera 105. The computing system 100 can use other algorithms to determine the vehicle make and type, such as the scaling, k-means clustering, or any other image object recognition algorithms. The computing system 100 can determine the color of the other vehicle. For example, responsive to the photo sensor 130 detecting an object in front of the photo sensor 130, the computing system 100 can send a command to the camera 105 to zoom into the vehicle and take an image of the other vehicle. The computing system 100 can sample random points in the image to determine the color of the vehicle by taking the average of the red, blue, green values of the random sample points. The computing system 100 or the vehicle detection module can determine a matching score based on the meta data comparison of the features of other vehicles versus the features of the image of the vehicle taken from the camera 105. The meta data can include the make, model, and color of the vehicle. The meta data of vehicles can be pre-stored in memory 135 or retrieved from an external server via the communications unit 115. For example, once the computing system 100 determines the meta data of the vehicle extracted from the image of the vehicle taken from the camera 105, the computing system 100 can assign compare the meta data of the image versus the meta data of other vehicles using the nearest neighbor algorithm. The computing system 100 can determine which vehicle the vehicle from the image taken from the camera 105 is based on the nearest neighbor algorithm.

The computing system 100 can receive or access proximate car status data (ACT 535). The computing system 100 or content orchestration module executing on the system 100 can retrieve or access the status of another system 100 attached to another vehicle. The computing system 100 can retrieve or access the status of another system 100 attached to another vehicle from an external server via the communications unit 115. For example, the computing system 100 can send the vehicle location information and a request for a status of another vehicle with the system 100 to an external server via the communications unit 115. The external server in turn can send the status of other vehicle to the computing system 100 via the communications unit 115. Responsive to the status of the other vehicle, the computing system 100 can access, retrieve, or select content that has been accessed, retrieved, or selected by the other vehicle. The external server can orchestrate the content accessed, retrieved, or selected by the computing system 100. For example, responsive to the determination that there are multiple vehicles with the system 100 attached within a certain threshold distance, the external server can send related content to the systems 100 of these multiple vehicles. The external server can also orchestrate the content accessed, retrieved, or selected by the processor based on a campaign rule. The campaign rule can include which content should be accessed, retrieved, or selected based on the vehicle type information, location information, time information, vehicle acceleration information, proximate points of interest, proximate car data, et cetera. For example, a campaign rule can specify that all the systems 100 that are attached to minivans on a given street in a major metropolitan city select a particular content. In this example, upon determining that a vehicle has met the specifications of the campaign rule, the computing system 100 can retrieve the particular content from the external server via communications unit 115 in accordance with the campaign rule.

The computing system 100 can retrieve or access content based on the data (ACT 540). The computing system 100 or the content retrieval module executing on the computing system 100 can access or retrieve content from an external server via the communications unit 115. The computing system 100 access or retrieve the content stored in the memory 135. The computing system 100 can store the content retrieved or accessed from the external server via the communications unit 115 in the memory 135. The computing system 100 can access, retrieve, or select content from an external server via the communications unit 115 based on a number of parameters. The computing system 100 can select content from the memory 135 based on a number of parameters. The parameters can include the vehicle location data, proximate points of interest data, time data, vehicle acceleration data, relative velocity of the other vehicle et cetera. The computing system 100 or the content retrieval module can access, retrieve, or select content based on the location information, time information, vehicle type information associated with demographics information stored in a persona database. The persona database can be stored at an external server. The computing system 100 can access or retrieve data from the persona database via the communications unit 115. The persona database can contain demographics information that is dynamically updated and maintained. The computing system 100 or the content retrieval module can query demographics information based on location information, time information, and vehicle type information. The demographics information can include vehicle type information, location information, time information, and content that is associated with the vehicle type information, location information, and time information. The persona database can associate content with the vehicle information, the location information, and the time information. The computing system 100 or the content retrieval module can select content based on the demographics information stored in the persona database.

The computing system 100 can select content (ACT 545). The computing system 100, the content retrieval module, or a prioritization module executing on the computing system 100 can prioritize content retrieved or accessed from the external server via the communications unit 115 based on vehicle location data, proximate points of interest data, time data, and vehicle acceleration data. The computing system 100 can also estimate the conversion rate for the content based on the vehicle location data, proximate points of interest data, time data, vehicle acceleration data, and the content bid prices. The computing system 100 can retrieve or access the content bid prices from an external server via the communications unit 115. The computing system 100 can also assign weights to the vehicle location information, proximate points of interest information, time information, vehicle acceleration information, and content bid prices in determining the conversion rate. The computing system 100 or the content retrieval module can select the content with the highest estimated conversion rate for display in display 160. The computing system 100 can also prioritize content retrieve or accessed from the external server via the communications unit 115 based on type of content and the preferences indicated by the administrator. The computing system 100 can select the content with the highest priority or conversion rate for display in display 160. The computing system 100 can also default to selecting content when the type of content is a public announcement.

The computing system 100 can display content on the display (ACT 550). The computing system 100 can relay the content selected to the display 160. The computing system 100 can relay command signals to control the brightness of the display 160 via the PWM unit 145 and the front light pipe 150. The computing system 100 can relay the pre-rendered image of the content to the mapper 155. The mapper 155 can translate or map the pre-rendered images of the content from the computing system 100 to a format compatible with the electrophoretic display 160. The mapper 155 can control which encapsulations in the electrophoretic display 160 to activate based on the colors in the pre-rendered image.

The computing system 100 can store content and associated location data (ACT 555). The computing system 100 or a content trail module executing on the computing system 100 can store the vehicle location data and the associated content. The computing system 100 can store the vehicle location information and the associated content in the memory 135. The computing system 100, responsive to a request from an electronic media device (e.g., a smartphone, tablet, or laptop), can send to the electronic media device the content that was selected at the vehicle location information proximate to the location of the electronic media device (e.g., 1-5 miles). The computing system 100 executing on the computing system 100 can store the vehicle location information and the associated content to an external server such as one in the cloud via the communications unit 115. The external server, responsive to a request from an electronic media device, can send to the electronic media device the content that was selected at the vehicle location information nearest to the location of the electronic media device.

The computing system 100 can verify whether the content was displayed on the display (ACT 560). The computing system 100 or an impression verification module executing on the computing system 100 can confirm whether the display 160 has displayed the content. The computing system 100 can take a screenshot of the display 160. The processor 160 can then compare the screenshot to the image of the content using a number of image recognition techniques. For example, the processor 160 can execute scale the image and screenshot down to lower resolution and compute the difference of the grayscale per pixel. In this example, if the total difference is above a certain threshold (e.g., 2-8%), the processor 160 can determine that the image and screenshot are different and indicate that the display 160 has not properly displayed the content.

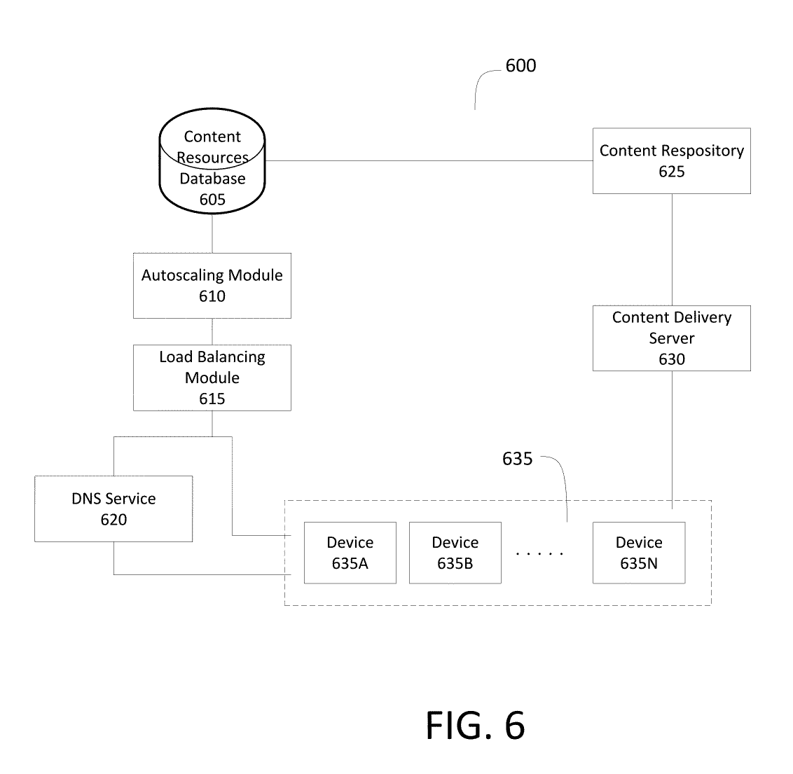

FIG. 6 is a block diagram depicting a content delivery architecture for a system for displaying content from a vehicle, according to an illustrative implementation. The content delivery system 600 can include a content resources database 605, autoscaling module 610, load balancing module 615, domain name system (DNS) service 620, a content repository 625, a content delivery server 630, and a plurality of devices 635. The content delivery system 600 can include the various functionalities of the external server mentioned in the description of system 100 and FIG. 1. Various components of the content delivery system 600 can be implemented using Amazon's Web Services (AWS). For example, the autoscaling module 610, load balancing module 615, and the DNS service 620 can be implemented using AWS's autobalancing, elastic load balancing, and Amazon's Route 53 services respectively.

The content resources database 605 can contain links or addresses to content stored in the content repository 625. The links or addresses stored in the content resources content 605 can uniquely identify the content stored in the content repository 625. The content resources database 605 can also contain other information associated with the content identified by the link or address, such as size, target audience, target location, target time, et cetera. The content resources database 605 can determine which content to serve, based on the proximate points of interest information, location information, time information, vehicle acceleration information, vehicle relative velocity information, proximate car information, and vehicle type information received from the one or more devices 635. The content resources database 605 can be included in one or more servers in the cloud.

The autoscaling module 610 can maintain availability of the content resources database 605. The autoscaling module 610 can increase or decrease capacity of the content resources database 605 based on network traffic and usage. For example, in response to a determination of a spike of devices 635 requesting access to the content resources database 605, the autoscaling module 610 can increase the capacity used in the content resources database 605. In this example, once the network traffic reduces to average levels, the autoscaling module 610 can decrease the capacity of the content resources database 605 to normal levels. The autoscaling module 610 be included as a module or component included in one or more servers in the cloud.

The load balancing module 615 can distribute network traffic between the content resources database 605 and the devices 635. For example, when the plurality of devices 635 send a request for content to the content resources database 605, the load balancing module 615 can automatically distribute incoming traffic across multiple servers that host the content resources database 605. The load balancing module 615 can work in conjunction with the autoscaling module 610 to handle spikes in network traffic from the plurality of devices 635. The load balancing module 615 can be included as a module or component included in one or more servers in the cloud.

The DNS service 620 can route network traffic between the plurality of devices 635 and the load balancing module 615. The DNS service 620 can update name server in a domain name system (DNS). The DNS service 620 can resolve domain name and IP address issues that can arise from changes in domain names and IP addresses. The DNS service 620 can manage traffic between the plurality of devices 635 and the load balancing module 615 through various routing techniques, such as round-robin DNS, scheduling, load balancing, Geo DNS, or a specified routing policy (e.g., latency).

The content repository 625 can contain content. The content repository 625 can store content uploaded by content offerors. The content repository 625 can relay the links, address, and other information to the content resources database 605. Responsive to a request for a specific content from one or more devices 635, the content repository 625 can send the specific content to the one or more devices 635 directly or via the content delivery server 630. The content repository 625 can upload content to the memory of one or more devices 635 directly or via the content delivery server 630. Responsive to a request to send a specific content to a particular device 635, the content repository 625 can upload content to the particular device 635 directly or via the content delivery server 630.

The content delivery server 630 can deliver content to the plurality of devices 635. The content can request for a specific content from the content repository 625 in response to receiving a request for specific content from one or more devices 635. The content delivery server 630 can upload content to the memory of one or more devices 635. Responsive to a request to send a specific content to a particular device 635, the content delivery server 630 can upload content to the particular device 635.

The plurality of devices 635 can include system 100, device 200, or electronics media devices, such as smart phones, tablets, and laptops. Each device 635A-N in the plurality of devices 635 can be linked by Bluetooth or WiFi.

It may be helpful to describe aspects of the operating environment as well as associated system components (e.g., hardware elements) in connection with the methods and systems described herein. Referring to FIG. 7A, an embodiment of a network environment is depicted. In brief overview, the network environment includes one or more clients 702a-702n (also generally referred to as local machine(s) 702, client(s) 702, client node(s) 702, client machine(s) 702, client computer(s) 702, client device(s) 702, endpoint(s) 702, or endpoint node(s) 702) in communication with one or more servers 706a-706n (also generally referred to as server(s) 706, node 706, or remote machine(s) 706) via one or more networks 704. In some embodiments, a client 702 has the capacity to function as both a client node seeking access to resources provided by a server and as a server providing access to hosted resources for other clients 702a-702n.

Although FIG. 7A shows a network 704 between the clients 702 and the servers 706, the clients 702 and the servers 706 can be on the same network 704. In some embodiments, there are multiple networks 704 between the clients 702 and the servers 706. In one of these embodiments, a network 704′ (not shown) can be a private network and a network 704 can be a public network. In another of these embodiments, a network 704 can be a private network and a network 704′ a public network. In still another of these embodiments, networks 704 and 704′ can both be private networks.

The network 704 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods e.g. FDMA, TDMA, CDMA, or SDMA. In some embodiments, different types of data can be transmitted via different links and standards. In other embodiments, the same types of data can be transmitted via different links and standards.

The network 704 can be any type and/or form of network. The geographical scope of the network 704 can vary widely and the network 704 can be a body area network (BAN), a personal area network (PAN), a local-area network (LAN), e.g. Intranet, a metropolitan area network (MAN), a wide area network (WAN), or the Internet. The topology of the network 704 can be of any form and can include, e.g., any of the following: point-to-point, bus, star, ring, mesh, or tree. The network 704 can be an overlay network which is virtual and sits on top of one or more layers of other networks 704′. The network 704 can be of any such network topology as known to those ordinarily skilled in the art capable of supporting the operations described herein. The network 704 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 704 can be a type of a broadcast network, a telecommunications network, a data communication network, or a computer network.

In some embodiments, the system can include multiple, logically-grouped servers 706. In one of these embodiments, the logical group of servers can be referred to as a server farm 780 or a machine farm 780. In another of these embodiments, the servers 706 can be geographically dispersed. In other embodiments, a machine farm 780 can be administered as a single entity. In still other embodiments, the machine farm 780 includes a plurality of machine farms 780. The servers 706 within each machine farm 780 can be heterogeneous—one or more of the servers 706 or machines 706 can operate according to one type of operating system platform (e.g., WINDOWS NT, manufactured by Microsoft Corp. of Redmond, Wash.), while one or more of the other servers 706 can operate on according to another type of operating system platform (e.g., Unix, Linux, or Mac OS X).

In one embodiment, servers 706 in the machine farm 780 can be stored in high-density rack systems, along with associated storage systems, and located in an enterprise data center. In this embodiment, consolidating the servers 706 in this way can improve system manageability, data security, the physical security of the system, and system performance by locating servers 706 and high performance storage systems on localized high performance networks. Centralizing the servers 706 and storage systems and coupling them with advanced system management tools allows more efficient use of server resources.

The servers 706 of each machine farm 780 do not need to be physically proximate to another server 706 in the same machine farm 780. Thus, the group of servers 706 logically grouped as a machine farm 780 can be interconnected using a wide-area network (WAN) connection or a metropolitan-area network (MAN) connection. For example, a machine farm 780 can include servers 706 physically located in different continents or different regions of a continent, country, state, city, campus, or room. Data transmission speeds between servers 706 in the machine farm 780 can be increased if the servers 706 are connected using a local-area network (LAN) connection or some form of direct connection. Additionally, a heterogeneous machine farm 780 can include one or more servers 706 operating according to a type of operating system, while one or more other servers 706 execute one or more types of hypervisors rather than operating systems. In these embodiments, hypervisors can be used to emulate virtual hardware, partition physical hardware, virtualize physical hardware, and execute virtual machines that provide access to computing environments, allowing multiple operating systems to run concurrently on a host computer. Native hypervisors can run directly on the host computer. Hypervisors can include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors can run within an operating system on a second software level. Examples of hosted hypervisors can include VMware Workstation and VIRTUALBOX.

Management of the machine farm 780 can be de-centralized. For example, one or more servers 706 can comprise components, subsystems and modules to support one or more management services for the machine farm 780. In one of these embodiments, one or more servers 706 provide functionality for management of dynamic data, including techniques for handling failover, data replication, and increasing the robustness of the machine farm 780. Each server 706 can communicate with a persistent store and, in some embodiments, with a dynamic store.

Server 706 can be a file server, application server, web server, proxy server, appliance, network appliance, gateway, gateway server, virtualization server, deployment server, SSL VPN server, or firewall. In one embodiment, the server 706 can be referred to as a remote machine or a node. In another embodiment, a plurality of nodes 290 can be in the path between any two communicating servers.

Referring to FIG. 7B, a cloud computing environment is depicted. A cloud computing environment can provide client 702 with one or more resources provided by a network environment. The cloud computing environment can include one or more clients 702a-702n, in communication with the cloud 708 over one or more networks 704. Clients 702 can include, e.g., thick clients, thin clients, and zero clients. A thick client can provide at least some functionality even when disconnected from the cloud 708 or servers 706. A thin client or a zero client can depend on the connection to the cloud 708 or server 706 to provide functionality. A zero client can depend on the cloud 708 or other networks 704 or servers 706 to retrieve operating system data for the client device. The cloud 708 can include back end platforms, e.g., servers 706, storage, server farms or data centers.

The cloud 708 can be public, private, or hybrid. Public clouds can include public servers 706 that are maintained by third parties to the clients 702 or the owners of the clients. The servers 706 can be located off-site in remote geographical locations as disclosed above or otherwise. Public clouds can be connected to the servers 706 over a public network. Private clouds can include private servers 706 that are physically maintained by clients 702 or owners of clients. Private clouds can be connected to the servers 706 over a private network 704. Hybrid clouds 708 can include both the private and public networks 704 and servers 706.

The cloud 708 can also include a cloud based delivery, e.g. Software as a Service (SaaS) 710, Platform as a Service (PaaS) 712, and Infrastructure as a Service (IaaS) 714. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS can include infrastructure and services (e.g., EG-32) provided by OVH HOSTING of Montreal, Quebec, Canada, AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers can offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers can offer the resources that PaaS provides, including storage, networking, servers, virtualization, operating system, middleware, or runtime resources. In some embodiments, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif. Clients 702 can access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards can allow clients access to resources over HTTP, and can use Representational State Transfer (REST) protocol or Simple Object Access Protocol (SOAP). Clients 702 can access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that can be built on REST, HTTP, XML, or other protocols. Clients 702 can access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 702 can also access SaaS resources through smartphone or tablet applications, including, e.g., Salesforce Sales Cloud, or Google Drive app. Clients 702 can also access SaaS resources through the client operating system, including, e.g., Windows file system for DROPBOX.

In some embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

The client 702 and server 706 can be deployed as and/or executed on any type and form of computing device, e.g. a computer, network device or appliance capable of communicating on any type and form of network and performing the operations described herein. FIGS. 7C and 7D depict block diagrams of a computing device 700 useful for practicing an embodiment of the client 702 or a server 706. As shown in FIGS. 7C and 7D, each computing device 700 includes a central processing unit 721, and a main memory unit 722. As shown in FIG. 7C, a computing device 700 can include a storage device 728, an installation device 716, a network interface 718, an I/O controller 723 and display devices 724a-724n. I/O devices can include, for example, a keyboard and mouse. The storage device 728 can include, without limitation, an operating system and software. As shown in FIG. 7D, each computing device 700 can also include additional optional elements, e.g. a memory port 703, a bridge 770, one or more input/output devices 730a-730n (generally referred to using reference numeral 730), and a cache memory 740 in communication with the central processing unit 721.

The central processing unit 721 is any logic circuitry that responds to and processes instructions fetched from the main memory unit 722. In many embodiments, the central processing unit 721 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 700 can be based on any of these processors, or any other processor capable of operating as described herein. The central processing unit 721 can utilize instruction level parallelism, thread level parallelism, different levels of cache, and multi-core processors. A multi-core processor can include two or more processing units on a single computing component. Examples of multi-core processors include the AMD PHENOM IIX2, INTEL CORE i5 and INTEL CORE i7.

Main memory unit 722 can include one or more memory chips capable of storing data and allowing any storage location to be directly accessed by the microprocessor 721. Main memory unit 722 can be volatile and faster than storage 728 memory. Main memory units 722 can be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 722 or the storage 728 can be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 722 can be based on any of the above described memory chips, or any other available memory chips capable of operating as described herein. In the embodiment shown in FIG. 7C, the processor 721 communicates with main memory 722 via a system bus 750 (described in more detail below). FIG. 7D depicts an embodiment of a computing device 700 in which the processor communicates directly with main memory 722 via a memory port 703. For example, in FIG. 7D the main memory 722 can be DRDRAM.

FIG. 7D depicts an embodiment in which the main processor 721 communicates directly with cache memory 740 via a secondary bus, sometimes referred to as a backside bus. In other embodiments, the main processor 721 communicates with cache memory 740 using the system bus 750. Cache memory 740 typically has a faster response time than main memory 722 and is typically provided by SRAM, BSRAM, or EDRAM. In the embodiment shown in FIG. 7D, the processor 721 communicates with various I/O devices 730 via a local system bus 750. Various buses can be used to connect the central processing unit 721 to any of the I/O devices 730, including a PCI bus, a PCI-X bus, or a PCI-Express bus, or a NuBus. For embodiments in which the I/O device is a video display 724, the processor 721 can use an Advanced Graphics Port (AGP) to communicate with the display 724 or the I/O controller 723 for the display 724. FIG. 7D depicts an embodiment of a computer 700 in which the main processor 721 communicates directly with I/O device 730b or other processors 721′ via HYPERTRANSPORT, RAPIDIO, or INFINIBAND communications technology. FIG. 7D also depicts an embodiment in which local busses and direct communication are mixed: the processor 721 communicates with I/O device 730a using a local interconnect bus while communicating with I/O device 730b directly.

A wide variety of I/O devices 730a-730n can be present in the computing device 700. Input devices can include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices can include video displays, graphical displays, speakers, headphones, inkjet printers, laser printers, and 3D printers.

Devices 730a-730n can include a combination of multiple input or output devices, including, e.g., Microsoft KINECT, Nintendo Wiimote for the WII, Nintendo WII U GAMEPAD, or Apple IPHONE. Some devices 730a-730n allow gesture recognition inputs through combining some of the inputs and outputs. Some devices 730a-730n provides for facial recognition which can be utilized as an input for different purposes including authentication and other commands. Some devices 730a-730n provides for voice recognition and inputs, including, e.g., Microsoft KINECT, SIRI for IPHONE by Apple, Google Now or Google Voice Search.

Additional devices 730a-730n have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 730a-730n, display devices 724a-724n or group of devices can be augment reality devices. The I/O devices can be controlled by an I/O controller 723 as shown in FIG. 7C. The I/O controller can control one or more I/O devices, such as, e.g., a keyboard 126 and a pointing device 127, e.g., a mouse or optical pen. Furthermore, an I/O device can also provide storage and/or an installation medium 716 for the computing device 700. In still other embodiments, the computing device 700 can provide USB connections (not shown) to receive handheld USB storage devices. In further embodiments, an I/O device 730 can be a bridge between the system bus 750 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 724a-724n can be connected to I/O controller 723. Display devices can include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays can use, e.g. stereoscopy, polarization filters, active shutters, or autostereoscopy. Display devices 724a-724n can also be a head-mounted display (HMD). In some embodiments, display devices 724a-724n or the corresponding I/O controllers 723 can be controlled through or have hardware support for OPENGL or DIRECTX API or other graphics libraries.

In some embodiments, the computing device 700 can include or connect to multiple display devices 724a-724n, which each can be of the same or different type and/or form. As such, any of the I/O devices 730a-730n and/or the I/O controller 723 can include any type and/or form of suitable hardware, software, or combination of hardware and software to support, enable or provide for the connection and use of multiple display devices 724a-724n by the computing device 700. For example, the computing device 700 can include any type and/or form of video adapter, video card, driver, and/or library to interface, communicate, connect or otherwise use the display devices 724a-724n. In one embodiment, a video adapter can include multiple connectors to interface to multiple display devices 724a-724n. In other embodiments, the computing device 700 can include multiple video adapters, with each video adapter connected to one or more of the display devices 724a-724n. In some embodiments, any portion of the operating system of the computing device 700 can be configured for using multiple displays 724a-724n. In other embodiments, one or more of the display devices 724a-724n can be provided by one or more other computing devices 700a or 700b connected to the computing device 700, via the network 704. In some embodiments software can be designed and constructed to use another computer's display device as a second display device 724a for the computing device 700. For example, in one embodiment, an Apple iPad can connect to a computing device 700 and use the display of the device 700 as an additional display screen that can be used as an extended desktop. One ordinarily skilled in the art will recognize and appreciate the various ways and embodiments that a computing device 700 can be configured to have multiple display devices 724a-724n.

Referring again to FIG. 7C, the computing device 700 can comprise a storage device 728 (e.g. one or more hard disk drives or redundant arrays of independent disks) for storing an operating system or other related software, and for storing application software programs. Examples of storage device 728 include, e.g., hard disk drive (HDD); optical drive including CD drive, DVD drive, or BLU-RAY drive; solid-state drive (SSD); USB flash drive; or any other device suitable for storing data. Some storage devices can include multiple volatile and non-volatile memories, including, e.g., solid state hybrid drives that combine hard disks with solid state cache. Some storage device 728 can be non-volatile, mutable, or read-only. Some storage device 728 can be internal and connect to the computing device 700 via a bus 750. Some storage device 728 can be external and connect to the computing device 700 via a I/O device 730 that provides an external bus. Some storage device 728 can connect to the computing device 700 via the network interface 718 over a network 704, including, e.g., the Remote Disk for MACBOOK AIR by Apple. Some client devices 700 may not require a non-volatile storage device 728 and can be thin clients or zero clients 702. Some storage device 728 can also be used as an installation device 716, and can be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 700 can also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform can facilitate installation of software on a client device 702. An application distribution platform can include a repository of applications on a server 706 or a cloud 708, which the clients 702a-702n can access over a network 704. An application distribution platform can include application developed and provided by various developers. A user of a client device 702 can select, purchase and/or download an application via the application distribution platform.

Furthermore, the computing device 700 can include a network interface 718 to interface to the network 704 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.17A/b/g/n/ac CDMA, GSM, WiMax and direct asynchronous connections). In one embodiment, the computing device 700 communicates with other computing devices 700′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 718 can comprise a built-in network adapter, network interface card, PCMCIA network card, EXPRESSCARD network card, card bus network adapter, wireless network adapter, USB network adapter, modem or any other device suitable for interfacing the computing device 700 to any type of network capable of communication and performing the operations described herein.

A computing device 700 of the sort depicted in FIGS. 7B and 7C can operate under the control of an operating system, which controls scheduling of tasks and access to system resources. The computing device 700 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, can be used on zero clients or thin clients, including, e.g., CHROMEBOOKS.

The computer system 700 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 700 has sufficient processor power and memory capacity to perform the operations described herein. In some embodiments, the computing device 700 can have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 700 is a gaming system. For example, the computer system 700 can comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 700 is a digital audio player such as the Apple IPOD, IPOD Touch, and IPOD NANO lines of devices, manufactured by Apple Computer of Cupertino, Calif. Some digital audio players can have other functionality, including, e.g., a gaming system or any functionality made available by an application from a digital application distribution platform. For example, the IPOD Touch can access the Apple App Store. In some embodiments, the computing device 700 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 700 is a tablet e.g. the IPAD line of devices by Apple; GALAXY TAB family of devices by Samsung; or KINDLE FIRE, by Amazon.com, Inc. of Seattle, Wash. In other embodiments, the computing device 700 is an eBook reader, e.g. the KINDLE family of devices by Amazon.com, or NOOK family of devices by Barnes & Noble, Inc. of New York City, N.Y.

In some embodiments, the communications device 702 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 702 is a laptop or desktop computer equipped with a web browser and a microphone and speaker system, e.g. a telephony headset. In these embodiments, the communications devices 702 are web-enabled and can receive and initiate phone calls. In some embodiments, a laptop or desktop computer is also equipped with a webcam or other video capture device that enables video chat and video call.

In some embodiments, the status of one or more machines 702, 706 in the network 704 are monitored, generally as part of network management. In one of these embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above.

Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system for displaying content from a vehicle, comprising:
a computing system having one or more processors placed on a first vehicle;
a vehicle location module, executing on the computing system, that accesses a vehicle location of the first vehicle from an external server via a communication unit;
a vehicle detection module, executing on the computing system, that detects whether a second vehicle is behind the first vehicle based on a first sensor, and responsive to the detection identifies a vehicle type of the second vehicle based on a second sensor and determines a relative velocity of the second vehicle;
a vehicle accelerometer module, executing on the computing system, that measures a vehicle acceleration of the first vehicle;
a content retrieval module, executing on the computing system, that accesses a content based on the vehicle location, the vehicle type, the relative velocity, and the vehicle acceleration;
a content prioritization module, executing on the computing system, that selects the content for display based on the vehicle location, the vehicle type, the relative velocity, and the vehicle acceleration; and
an electrophoretic display that responsive to the selection displays the selected content.

2. The system of claim 1, comprising:
a time module, executing on the computing system, that determines a time information;
the content retrieval module that accesses the content further based on the time information; and
the content prioritization module that selects the content for display further based on the time information.

3. The system of claim 1, comprising:
the vehicle location module that accesses a point of interest based on the vehicle location of the first vehicle from the external server via the communications unit;
the content retrieval module that accesses the content further based on the point of interest; and
the content prioritization module, executing on the computing system, that selects the content for display further based on the point of interest.

4. The system of claim 1, wherein the content retrieval module adjusts the content for display based on the relative velocity.

5. The system of claim 1, wherein the content retrieval module adjusts the content for display based on the vehicle acceleration.

6. The system of claim 1, comprising a content trail module, executing on the computing system, that associates the content with the vehicle location.

7. The system of claim 6, wherein responsive to a request from an electronic media device near the vehicle location, the content trail module transmits the content associated with the vehicle location.

8. The system of claim 1, comprising an impression verification module executing on the computing system that determines whether the content was displayed on the electrophoretic display.

9. The system of claim 1, comprising a front light pipe to illuminate the electrophoretic display.

10. The system of claim 1, comprising a solar panel placed on the first vehicle capable of providing electricity to the computing system.

11. A method of displaying content from a vehicle, comprising:
accessing, by a vehicle location module executing on a computing system having one or more processors placed on a first vehicle, a vehicle location of the first vehicle from an external server via a communications unit;
detecting, by a vehicle detection module executing on the computing system, whether a second vehicle is behind the first vehicle based on a first sensor;
identifying, by the vehicle detection module responsive to the detection of the second vehicle, a vehicle type of the second vehicle based on a second sensor;
determining, by the vehicle detection module responsive to the detection of the second vehicle, a relative velocity of the second vehicle;
measuring, by a vehicle accelerometer module executing on the computing system, a vehicle acceleration of the first vehicle;
accessing, by a content retrieval module executing on the computing system, a content based on the vehicle location, the vehicle type, the relative velocity, and the vehicle acceleration;
selecting, by a content prioritization module executing on the computing system, a content based on the vehicle location, the vehicle type, the relative velocity, and the vehicle acceleration; and
displaying, responsive to the selection of the content, the content on an electrophoretic display.

12. The method of claim 11, comprising:
determining, by a time module executing on the computing system, a time information;
accessing, by the content retrieval module, the content further based on the time information; and
selecting, by the content prioritization module, the content based on the time information.

13. The method of claim 11, comprising:
accessing, by the vehicle location module, a point of interest based on the vehicle location of the first vehicle from the external server via the communications unit;
accessing, by the content retrieval module, the content further based on the point of interest; and
selecting, by the content prioritization module, the content based on the point of interest.

14. The method of claim 11, comprising adjusting, by the content retrieval module, the content for display based on the relative velocity.

15. The method of claim 11, comprising adjusting, by the content retrieval module, the content for display based on the vehicle acceleration.

16. The method of claim 11, comprising associating, by a content trail module executing on the computing system, the content with the vehicle location.

17. The method of claim 16, comprising transmitting, by the content trail module responsive to a request from an electronic media device near the vehicle location, the content associated with the vehicle location.

18. The method of claim 11, comprising determining, by an impression verification module, whether the content was displayed on the electrophoretic display.

19. The method of claim 11, comprising illuminating, by a front light pipe, the electrophoretic display.

20. The method of claim 11, comprising providing, by a solar panel placed on the first vehicle, electricity to the computing system.
